(19) United States
(12) Patent Application Publication
(10) Pub. No.: US 2026/0253551 A1
(43) Pub. Date: Aug. 27, 2026

(54) GATE DRIVING CIRCUIT UNIT AND DRIVING METHOD THEREOF, GATE DRIVING CIRCUIT, AND DISPLAY DEVICE

(71) Applicants: HEFEI BOE JOINT TECHNOLOGY CO., LTD., Hefei (CN); BOE TECHNOLOGY GROUP CO., LTD., Beijing (CN); BEIJING BOE TECHNOLOGY DEVELOPMENT CO., LTD., Beijing (CN)

(72) Inventors: Zhidong YUAN, Beijing (CN); Yongqian LI, Beijing (CN)

(21) Appl. No.: 18/994,369

(22) PCT Filed: Apr. 28, 2024
(86) PCT No.: PCT/CN2024/090264

§ 371 Date: Jan. 14, 2025

(30) Foreign Application Priority Data
May 29, 2023 (CN) 202310622262.0

(51) Int. Cl. G09G 3/3266

(52) U.S. Cl. CPC G09G 3/3266; G09G 2300/0408; G09G 2300/0814; G09G 2300/0819; G09G 2310/0245; G09G 2310/0248; G09G 2320/0233; G09G 2330/021

(57) ABSTRACT

A gate driving circuit unit, a driving method thereof, a gate driving circuit, and a display device. The gate driving circuit unit includes a first input circuit; a second input circuit; an output circuit; a pre-charging circuit; and a first pull-down circuit; the output terminal of the first input circuit and the input terminal of the second input circuit are connected with a first node, the output terminal of the second input circuit and the control terminal of the output circuit are connected with a second node, the output terminal of the pre-charging circuit and the control terminal of the second input circuit are connected with a third node, the first pull-down circuit is configured to pull down a potential of the second node.

The present application claims the priority of the Chinese Patent Application No. 202310622262.0, filed on May 29, 2023, which is incorporated herein by reference as part of the disclosure of the present application.

### TECHNICAL FIELD

Embodiments of the present disclosure relate to a gate driving circuit unit, a driving method of the gate driving circuit unit, a gate driving circuit, and a display device.

### BACKGROUND

With the continuous development of display technology, the market has put forward higher requirements for low cost, narrow frame, and thin and lightweight design of display devices. In this regard, Gate Driver on Array (GOA) technology has become a research hotspot for major manufacturers because of its advantages such as narrow bezel and lightweight design.

GOA technology integrates the gate driving circuit on an array substrate arranged with a pixel unit array, so that the gate driving circuit can directly provide a gate driving signal to the pixel unit array without the need for an additional gate driving chip and a corresponding binding structure, thus the cost and the frame width can be reduced. Generally, the GOA technology includes a plurality of gate driving circuit units, so that the display product can display colorful images.

On the other hand, active-matrix organic light-emitting diode (AMOLED) display technology has gradually become the choice of various electronic products due to its advantages such as high contrast, wide viewing angle, fast response speed, and light weight. By incorporating the GOA technology into AMOLED display devices, it is possible to achieve display devices with narrower borders, thinner weight, and higher integration.

### SUMMARY

Embodiments of the present disclosure provide a gate driving circuit unit and its driving method, a gate driving circuit, and a display device. By connecting the control terminal of the pre-charging circuit with the second clock signal terminal, the gate driving circuit unit can control the pre-charging circuit by the clock signal to write the first power supply voltage into the third node, thus the conduction and disconnection of the second input circuit can be controlled without cascading, and the gate driving circuit unit can work independently, so that the gate driving circuit using the gate driving circuit unit can randomly select a sub-pixel row. In this way, on the one hand, the gate driving circuit using the gate driving circuit unit can partially refresh the display screen without performing line-by-line scanning, thereby greatly improving the refresh frequency; on the other hand, the gate driving circuit using the gate driving circuit unit can output “random frame shift”, thereby effectively eliminating the compensation horizontal stripes.

At least one embodiment of the present disclosure provides a gate driving circuit unit, which includes: a first input circuit, including a control terminal, an input terminal and an output terminal, the input terminal of the first input circuit is connected with a first power supply voltage; a second input circuit, including a control terminal, an input terminal and an output terminal; an output circuit, including a control terminal, an input terminal and an output terminal, the input terminal of the output circuit is connected with a first clock signal terminal; a pre-charging circuit, including a control terminal, an input terminal and an output terminal, the control terminal of the pre-charging circuit is connected with a second clock signal terminal, and the input terminal of the pre-charging circuit is connected with the first power supply voltage; and a first pull-down circuit, including a control terminal, an input terminal and an output terminal, the output terminal of the first input circuit and the input terminal of the second input circuit are connected with a first node, the output terminal of the second input circuit and the control terminal of the output circuit are connected with a second node, the output terminal of the pre-charging circuit and the control terminal of the second input circuit are connected with a third node, the first pull-down circuit is configured to pull down a potential of the second node.

For example, in the gate driving circuit unit provided by an embodiment of the present disclosure, the control terminal of the first pull-down circuit is connected with a third clock signal terminal, and is configured to pull down the potential of the second node in response to a signal on the third clock signal terminal.

For example, the gate driving circuit unit provided by an embodiment of the present disclosure further includes: a pull-down maintenance circuit, including a control terminal, an input terminal and an output terminal, the input terminal of the pull-down maintenance circuit is connected with the third node, and the output terminal of the pull-down maintenance circuit is connected with the second clock signal terminal; and a gating circuit, including an input terminal, an output terminal and a plurality of gating sub-circuits connected in parallel between the input terminal and the output terminal of the gating circuit, the input terminal of the gating circuit is connected with the control terminal of the pull-down maintenance circuit, and the output terminal of the gating circuit is connected with the third clock signal terminal.

For example, in the gate driving circuit unit provided by an embodiment of the present disclosure, each of the gating sub-circuits includes a gating transistor, the gating transistor includes a gate electrode, a first electrode and a second electrode, the first electrode of the gating transistor is connected with the input terminal of the gating circuit, and the second electrode of the gating transistor is connected with the output terminal of the gating circuit.

For example, in the gate driving circuit unit provided by an embodiment of the present disclosure, the pull-down maintenance circuit includes a first pull-down maintenance transistor and a second pull-down maintenance transistor, the first pull-down maintenance transistor includes a gate electrode, a first electrode and a second electrode, and the second pull-down maintenance transistor includes a gate electrode, a first electrode and a second electrode, the first electrode of the first pull-down maintenance transistor is connected with the third node, the output terminal of the first pull-down maintenance transistor is connected with the input terminal of the second pull-down maintenance transistor, and the output terminal of the second pull-down maintenance transistor is connected with the second clock signal terminal.

For example, in the gate driving circuit unit provided by an embodiment of the present disclosure, the input terminal of the first pull-down circuit is connected to the second node, and the output terminal of the first pull-down circuit is connected with a second power supply voltage.

For example, in the gate driving circuit unit provided by an embodiment of the present disclosure, the first pull-down circuit includes a first pull-down transistor and a second pull-down transistor, the first pull-down transistor includes a gate electrode, a first electrode, and a second electrode, and the second pull-down transistor includes a gate electrode, a first electrode, and a second electrode, the first electrode of the first pull-down transistor is connected with the second node, the second electrode of the first pull-down transistor is connected with the first electrode of the second pull-down transistor, and the second electrode of the second pull-down transistor is connected with the second power supply voltage.

For example, the gate driving circuit unit provided by an embodiment of the present disclosure further includes: an inverter module, including a control terminal and an output terminal, the control terminal of the inverter module is connected to the second node, and the output terminal of the inverter module is connected to a fourth node; and a first noise reduction circuit, including a control terminal, an input terminal and an output terminal, the input terminal of the first noise reduction circuit is connected to the first node, the control terminal of the first noise reduction circuit is connected to the fourth node, and the output terminal of the first noise reduction circuit is connected with a second power supply voltage; and the input terminal of the first pull-down circuit is connected with the first power supply voltage, and the output terminal of the first pull-down circuit is connected to the fourth node.

For example, the gate driving circuit unit provided by an embodiment of the present disclosure further includes: an inverter module, including a control terminal and an output terminal, the control terminal of the inverter module is connected to the second node, and the output terminal of the inverter module is connected to a fourth node; and a first noise reduction circuit, including a control terminal, an input terminal and an output terminal, the input terminal of the first noise reduction circuit is connected to the first node, the control terminal of the first noise reduction circuit is connected to the fourth node, and the output terminal of the first noise reduction circuit is connected with a second power supply voltage.

For example, in the gate driving circuit unit provided by an embodiment of the present disclosure, the first noise reduction circuit includes a first noise reduction transistor and a second noise reduction transistor, the first noise reduction transistor includes a gate electrode, a first electrode and a second electrode, and the second noise reduction transistor includes a gate electrode, a first electrode and a second electrode; the first electrode of the first noise reduction transistor is connected with the first node, the second electrode of the first noise reduction transistor is connected with the first electrode of the second noise reduction transistor, and the second electrode of the second noise reduction transistor is connected with the second power supply voltage, the gate electrode of the first noise reduction transistor and the gate electrode of the second noise reduction transistor are connected with the fourth node.

For example, the gate driving circuit unit provided by an embodiment of the present disclosure further includes: a second pull-down circuit, including a control terminal, an input terminal and an output terminal; a third pull-down circuit, including a control terminal, an input terminal and an output terminal; the input terminal of the second pull-down circuit is connected with the fourth node, the output terminal of the second pull-down circuit is connected with the input terminal of the third pull-down circuit, and the output terminal of the third pull-down circuit is connected with the second power supply voltage; the control terminal of the second pull-down circuit is connected with the third node, and the control terminal of the third pull-down circuit is connected with a fourth clock signal terminal.

For example, in the gate driving circuit unit provided by an embodiment of the present disclosure, the second pull-down circuit includes a third pull-down transistor, including a gate electrode, a first electrode and a second electrode, the third pull-down circuit includes a fourth pull-down transistor, including a gate electrode, a first electrode and a second electrode, the first electrode of the third pull-down transistor is connected with the fourth node, the second electrode of the third pull-down transistor is connected with the first electrode of the fourth pull-down transistor, and the second electrode of the fourth pull-down transistor is connected with the second power supply voltage, and the gate electrode of the third pull-down transistor is connected with the third node, and the gate electrode of the fourth pull-down transistor is connected with the fourth clock signal terminal.

For example, the gate driving circuit unit provided by an embodiment of the present disclosure further includes: a second noise reduction circuit, including a control terminal, an input terminal and an output terminal, the input terminal of the second noise reduction circuit is connected with the second node, the output terminal of the second noise reduction circuit is connected with the second power supply voltage, and the control terminal of the second noise reduction circuit is connected with the fourth node.

For example, the gate driving circuit unit provided by an embodiment of the present disclosure further includes: a third noise reduction circuit, including a control terminal, an input terminal and an output terminal, the input terminal of the third noise reduction circuit is connected with the output terminal of the output circuit, the output terminal of the third noise reduction circuit is connected with a third power supply voltage, and the control terminal of the third noise reduction circuit is connected with the fourth node.

For example, the gate driving circuit unit provided by an embodiment of the present disclosure further includes: a global reset circuit, including a first reset sub-circuit and a second reset sub-circuit, the first reset sub-circuit includes a control terminal, an input terminal and an output terminal, and the second reset sub-circuit includes a control terminal, an input terminal and an output terminal, the input terminal of the first reset sub-circuit is connected with the third node, and the output terminal of the first reset sub-circuit is connected with the second power supply voltage, the input terminal of the second reset sub-circuit is connected with the first power supply voltage, and the output terminal of the second reset sub-circuit is connected with the fourth node, the control terminal of the first reset sub-circuit and the control terminal of the second reset sub-circuit are both connected with a global reset signal.

For example, in the gate driving circuit unit provided by an embodiment of the present disclosure, the first input circuit includes a first input transistor, the second input circuit includes a second input transistor, the first input transistor includes a gate electrode, a first electrode and a second electrode, and the second input transistor includes a gate electrode, a first electrode and a second electrode, the first electrode of the first input transistor is connected with the first power supply voltage, the second electrode of the first input transistor is connected with the first electrode of the second input transistor, and the second electrode of the second input transistor is connected with the second node, and the gate electrode of the first input transistor is connected with a fourth clock signal terminal, and the gate electrode of the second input transistor is connected with the third node.

For example, in the gate driving circuit unit provided by an embodiment of the present disclosure, the first input circuit includes a first input transistor and a third input transistor, the second input circuit includes a second input transistor, the first input transistor includes a gate electrode, a first electrode and a second electrode, the second input transistor includes a gate electrode, a first electrode and a second electrode, and the third input transistor includes a gate electrode, a first electrode and a second electrode, the second electrode of the first input transistor is connected with the first electrode of the third input transistor, and the first electrode of the first input transistor, the gate electrode of the first input transistor, and the gate electrode of the third input transistor are connected with the fourth clock signal terminal, the second electrode of the third input transistor and the first electrode of the second input transistor are connected to the first node, and the gate electrode of the second input transistor is connected with the third node.

At least one embodiment of the present disclosure further provides a gate driving circuit, which includes a plurality of gate driving circuit units, each of the gate driving circuits includes any one of the abovementioned gate driving circuit units.

For example, in the gate driving circuit provided by an embodiment of the present disclosure, the plurality of gate driving circuit units include a plurality of gate driving circuit unit groups, each of the plurality of gate driving circuit unit groups includes a first gate driving circuit unit, a second gate driving circuit unit, a third gate driving circuit unit and a fourth gate driving circuit unit, the first clock signal terminal of the first gate driving circuit unit is connected with a first clock signal line, the first clock signal terminal of the first gate driving circuit unit is connected with a second clock signal line, the first clock signal terminal of the first gate driving circuit unit is connected with a third clock signal line, and the first clock signal terminal of the first gate driving circuit unit is connected with a fourth clock signal line.

At least one embodiment of the present disclosure further provides a display device, which includes any one of the abovementioned gate driving circuits.

At least one embodiment of the present disclosure further provides a driving method for a gate driving circuit unit, the gate driving circuit unit includes the abovementioned gate driving circuit unit, and the driving method includes: in a first stage, the pre-charging circuit responds to a signal on the second clock signal terminal, writes a first power supply voltage into the third node, and conducts a second input circuit; in a second stage, the first input circuit responds to a signal on the control terminal of the first input circuit, and pulls up the potential of the second node through the conducted second input circuit; in a third stage, the second node maintains a high level, and the output circuit responds to a signal of the second node, and outputs a signal on the first clock signal terminal as a gate drive signal; and in a fourth stage, the first pull-down circuit uses a second power supply voltage to pull down the potential of the second node.

### BRIEF DESCRIPTION OF DRAWINGS

In order to explain the technical solution of the embodiments of the present disclosure more clearly, the attached drawings of the embodiments of the present disclosure will be briefly introduced below. The attached drawings are only used to show some embodiments of the present disclosure, and are not limited to all embodiments of the present disclosure.

FIG. 1 is a schematic diagram of a 3T2C pixel driving circuit;

FIG. 2 is a timing diagram of a first gate driving signal and a second gate driving signal of the pixel driving circuit shown in FIG. 1;

FIG. 3 is a schematic diagram of a gate driving circuit unit;

FIG. 4 is a driving timing diagram of the gate driving circuit unit shown in FIG. 3;

FIG. 5 is a schematic diagram of a gate driving circuit unit provided by an embodiment of the present disclosure;

FIG. 6 is a timing diagram of a gate driving circuit unit provided by an embodiment of the present disclosure;

FIG. 7 is a schematic diagram of another gate driving circuit unit provided by an embodiment of the present disclosure;

FIG. 8 is a schematic diagram of another gate driving circuit unit provided by an embodiment of the present disclosure;

FIG. 9 is a schematic diagram of another gate driving circuit unit provided by an embodiment of the present disclosure;

FIG. 10 is a schematic diagram of another gate driving circuit unit provided by an embodiment of the present disclosure;

FIG. 11 is a schematic diagram of a gate driving circuit provided by an embodiment of the present disclosure;

FIG. 12 is a timing diagram of a gate signal of a gate driving circuit provided by an embodiment of the present disclosure; and

FIG. 13 is a schematic diagram of a display device provided by an embodiment of the present disclosure.

### DETAILED DESCRIPTION

In order to make the purpose, technical solution and advantages of the embodiments of the present disclosure clear, the technical solution of the embodiments of the disclosure will be described clearly and completely with the attached drawings. Obviously, the described embodiments are a part of the embodiments of the present disclosure, not the whole embodiments. Based on the described embodiments of the present disclosure, all other embodiments obtained by ordinary skilled in the art without creative labor belong to the scope of protection of the present disclosure.

Unless otherwise defined, technical terms or scientific terms used here shall have their ordinary meanings as understood by people with ordinary skills in the field to which this present disclosure belongs. The “first”, “second” and similar words used in the specification and claims of the present disclosure patent application do not indicate any order, quantity or importance, but are only used to distinguish different components. Similar words such as “including” or “containing” mean that the elements or objects appearing before the word cover the elements or objects listed after the word and their equivalents, without excluding other elements or objects. Similar words such as “connecting” or “connected” are not limited to physical or mechanical connection, but can include electrical connection, whether direct or indirect. In addition, when the number of one component or element is not specified in the following of the embodiment of the present disclosure, it refers to that the component or element can be one or more, or can be understood as at least one. “At least one” refers to one or more, and “a plurality of” means at least two.

It should be noted that, the transistors used in the embodiments of the present disclosure may be thin film transistors, field effect transistors, or other switching devices with the same characteristics. Since source electrodes and drain electrodes of the transistors are symmetrical, there is no structural difference between them, and they can be replaced with each other. In the embodiment of the present disclosure, in order to distinguish a source electrode and a drain electrode of each of the transistors, one of the source electrode and the drain electrode is referred to as a first electrode, and the other of the source electrode and the drain electrode is referred to as a second electrode. In addition, according to the characteristics of the transistors, the transistors can be divided into N-type transistors and P-type transistors; in a case that an N-type transistor is used, a high level is input to the gate electrode, the first electrode and the second electrode are conducted; in a case that a P-type transistor is used, a low level is input to the gate electrode, and the first electrode and the second electrode are conducted. The following embodiments are described using N-type transistors as examples, but the embodiments of the present disclosure include but are not limited thereto, the transistors in the embodiments of the present disclosure may also be P-type transistors. It is understandable that replacing the N-type transistors with the P-type transistors is something that a person skilled in the art can easily think of without any creative effort, and therefore it is also within the protection scope of the embodiments of the present disclosure.

In a design of a pixel driving circuit in an organic light emitting diode (OLED) display device, considering process limitations, the pixel driving circuit may use a combination of transistors and capacitors, such as a 3T1C circuit. Generally, an OLED display device needs to drive an organic light emitting element to emit light, and the current required for the organic light emitting element to emit light needs to be provided by a driving transistor. Therefore, in order to improve uniformity of light emitting of the OLED display device, consistency of the pixel driving circuit must be increased.

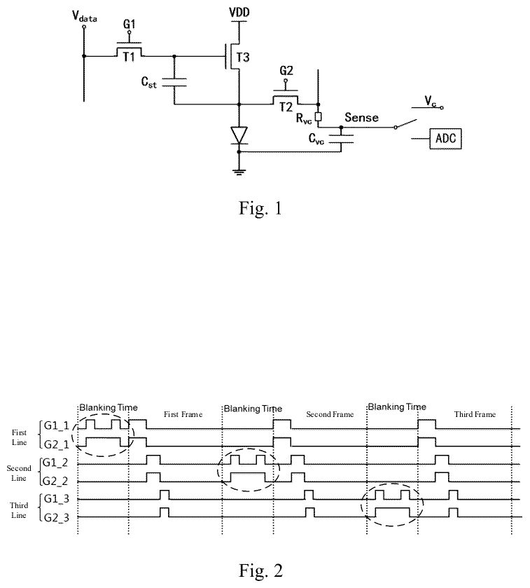

FIG. 1 is a schematic diagram of a 3T2C pixel driving circuit. As illustrated by FIG. 1, the pixel driving circuit includes three transistors T1, T2 and T3 and two capacitors Cst and Cvc. Driven by a first gate driving signal (or a scanning signal) G1, the transistor T1 conducts a data signal from a data line Vdata to a gate electrode of the transistor T3, furthermore, a driving voltage VDD can be selectively transmitted to a light emitting element (for example, an OLED light emitting element) according to the data signal, and cause it to emit light. In addition, the transistor T2 is selectively to be turned on or to be turned off under the driving of a second gate driving signal (or a sensing signal) G2, so that an analog-to-digital converter ADC can sense a voltage applied to a light emitting element, furthermore, a corresponding data signal/first gate driving signal can be adjusted to make the light emitting more uniform.

FIG. 2 is a timing diagram of a first gate driving signal and a second gate driving signal of the pixel driving circuit shown in FIG. 1. It should be noted that, although FIG. 2 only shows the working timing of the first gate driving signal G1 and the second gate driving signal G2 for three sub-pixel rows during three frames, those skilled in the art can determine the working timing of the first gate driving signal G1 and the second gate driving signal G2 for any sub-pixel row during any frame based on this. As illustrated by FIG. 2, a period of each frame can be roughly divided into two parts: a line shift part and a frame shift part. The row shift part refers to a part of a gate driving circuit unit that shifts row by row, such as parts shown under reference numerals “first frame”, “second frame” and “third frame” shown in FIG. 2, which show sequential shifts on adjacent rows in a same frame, thereby realizing row-by-row scanning of sub-pixel rows in a same frame. The frame shift part refers to a part of a gate driving circuit unit that shifts frame by frame, such as parts circled by dotted lines in FIG. 2, which are sequentially shifted in adjacent rows in adjacent frames, thereby sensing one sub-pixel row in each frame.

In a conventional external compensation method, as illustrated by FIG. 2, during a blanking time or a frame shift part of each frame, a gate driving circuit generates a sequential frame shift timing. However, this compensation method easily causes compensation horizontal stripes to be generated on the OLED display device, thus affecting the display image quality. Therefore, in order to realize the elimination of the “random frame shift” of the compensation horizontal stripes, it is needed to provide a gate driving circuit that can output the “random frame shift”.

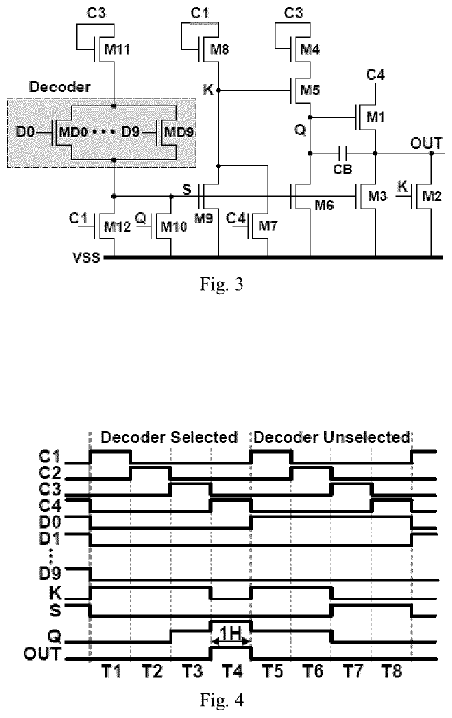

FIG. 3 is a schematic diagram of a gate driving circuit unit; and FIG. 4 is a driving timing diagram of the gate driving circuit unit shown in FIG. 3. As illustrated by FIG. 3 and FIG. 4, the above-mentioned gate driving circuit units are independent with each other and do not need to be cascaded, the purpose of random gating can be achieved by connecting transistors in a random gating sub-circuit Decoder shown in a dotted box to different signals without performing line-by-line scanning. However, due to an excessive number of transistors in the random selection sub-circuit Decoder shown in the dotted box, layout is very difficult. In addition, the gate driving circuit unit is not conducive to suppressing noise by shielding an S point. Therefore, providing a high-quality gate driving circuit capable of outputting “random frame shift” is an issue that needs to be urgently addressed in the art.

In this regard, embodiments of the present disclosure provide a gate driving circuit unit and its driving method, a gate driving circuit, and a display device. The gate driving circuit unit includes a first input circuit, a second input circuit, an output circuit, a pre-charging circuit and a first pull-down circuit; the first input circuit comprises a control terminal, an input terminal and an output terminal, and the input terminal of the first input circuit is connected with a first power supply voltage; the second input circuit includes a control terminal, an input terminal and an output terminal; the output circuit comprises a control terminal, an input terminal and an output terminal, in which the input terminal of the output circuit is connected with a first clock signal terminal; the pre-charging circuit comprises a control terminal, an input terminal and an output terminal, the control terminal of the pre-charging circuit is connected with a second clock signal terminal, and the input terminal of the pre-charging circuit is connected with the first power supply voltage; the first pull-down circuit includes a control terminal, an input terminal and an output terminal; the output terminal of the first input circuit and the input terminal of the second input circuit are connected with a first node, the output terminal of the second input circuit and the control terminal of the output circuit are connected with a second node, the output terminal of the pre-charging circuit and the control terminal of the second input circuit are connected with a third node, and the first pull-down circuit is configured to pull down a potential of the second node. In this way, by connecting the control terminal of the pre-charging circuit with the second clock signal terminal, the gate driving circuit unit can control the pre-charging circuit by the clock signal to write the first power supply voltage into the third node, thus the conduction and disconnection of the second input circuit can be controlled without cascading, and the gate driving circuit unit can work independently, so that the gate driving circuit using the gate driving circuit unit can randomly select a sub-pixel row. In this way, on the one hand, the gate driving circuit using the gate driving circuit unit can partially refresh the display screen without performing line-by-line scanning, thereby greatly improving the refresh frequency; on the other hand, the gate driving circuit using the gate driving circuit unit can output “random frame shift”, thereby effectively eliminating the compensation horizontal stripes.

Hereinafter, the gate driving circuit unit and a driving method thereof, the gate driving circuit, and the display device provided in the embodiment of the present disclosure will be described and introduced in detail with reference to the accompanying drawings.

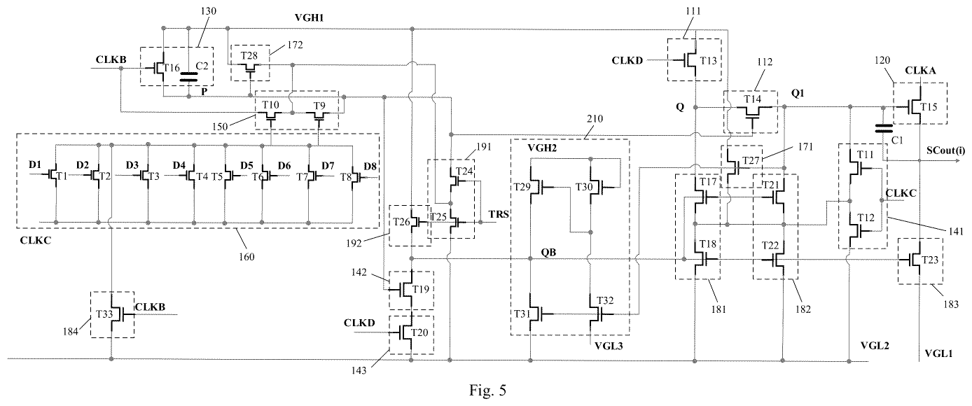

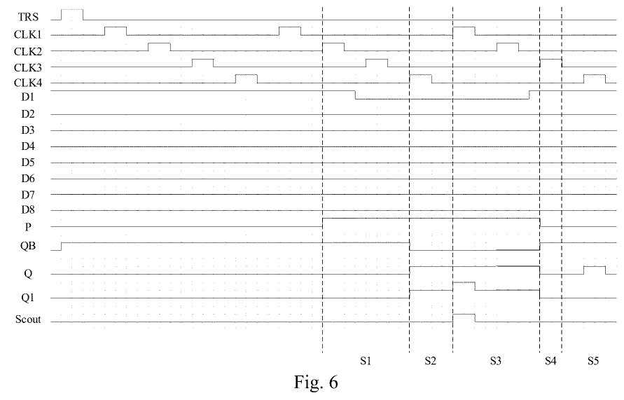

An embodiment of the present disclosure provides a gate driving circuit unit. FIG. 5 is a schematic diagram of a gate driving circuit unit provided by an embodiment of the present disclosure; and FIG. 6 is a timing diagram of a gate driving circuit unit provided by an embodiment of the present disclosure.

As illustrated by FIG. 5, the gate driving circuit unit 100 includes a first input circuit 111, a second input circuit 112, an output circuit 120, a pre-charging circuit 130, and a first pull-down circuit 141; the first input circuit 111 includes a control terminal, an input terminal and an output terminal, and the input terminal of the first input circuit 111 is connected with a first power supply voltage, for example, VGH1; the second input circuit 112 includes a control terminal, an input terminal and an output terminal; the output circuit 120 includes a control terminal, an input terminal and an output terminal, the input terminal of the output circuit 120 is connected with the first clock signal terminal CLKA, which is configured to receive the first clock signal or be connected with the first clock signal line; the pre-charging circuit 130 includes a control terminal, an input terminal and an output terminal, the control terminal of the pre-charging circuit 130 is connected with the second clock signal terminal CLKB, which is configured to receive the second clock signal or be connected with the second clock signal line; the input terminal of the pre-charging circuit 130 is connected with a first power supply voltage, such as VGH1.

As illustrated by FIG. 5, the first pull-down circuit 141 includes a control terminal, an input terminal, and an output terminal; the output terminal of the first input circuit 111 and the input terminal of the second input circuit 112 are connected with a first node Q, the output terminal of the second input circuit 112 and the control terminal of the output circuit 120 are connected with a second node Q1, the output terminal of the pre-charging circuit 130 and the control terminal of the second input circuit 112 are connected with a third node P, and the first pull-down circuit 141 is configured to pull down a potential of the second node.

In the gate driving circuit unit provided by the embodiment of the present disclosure, by connecting the control terminal of the pre-charging circuit with the second clock signal terminal, the gate driving circuit unit can control the pre-charging circuit through the clock signal to write the first power supply voltage into the third node, thus the conduction and disconnection of the second input circuit can be controlled. In this way, the gate driving circuit unit controls the second input circuit through the clock signal without cascading, thus the gate driving circuit unit can work independently, so that the gate driving circuit using the gate driving circuit unit can randomly select a sub-pixel row. In this way, on the one hand, the gate driving circuit using the gate driving circuit unit can partially refresh the display screen without line-by-line scanning, thus the refresh frequency is greatly improved; for example, in a case that only a partial region of the display screen needs to be refreshed, only the partial region of the display screen can be refreshed specifically, thus the refresh rate can be greatly improved. On the other hand, the gate driving circuit using the gate driving circuit unit can output “random frame shift”, thus the compensation horizontal stripes can be effectively eliminated.

In some examples, as illustrated by FIG. 5, the control terminal of the first pull-down circuit 141 is connected with the third clock signal terminal CLKC, and is configured to pull down the potential of the second node in response to a signal on the third clock signal terminal CLKC.

As illustrated by FIG. 6, in a first stage S1, a rising edge of a second clock signal CLK2 of a second clock signal terminal CLKB arrives, a third node P is set high, and the second input circuit 112 is conducted; in a case that a third clock signal CLK3 of a third clock signal terminal CLKC is high, the third node P may be maintained high; in a second stage S2, since the third node P is maintained high, in a case that the first input circuit 111 is conducted, the second node Q1 is pulled high; in a third stage S3, the second node Q1 is maintained at high, and a rising edge of a first clock signal CLK1 of a first clock signal terminal CLKA arrives and is output through an output circuit 120 as a gate driving signal; in a fourth stage S4, in a case that the third clock signal CLK3 of the third clock signal terminal CLKC reaches a high level, a first pull-down circuit 141 pulls down the potential of the second node Q1; and in a fifth stage S5, since the third node P is at a low level, the second node Q1 is guaranteed to be at a low level.

In the gate driving circuit unit provided by the embodiment of the present disclosure, by connecting the control terminal of the pre-charging circuit to the second clock signal terminal, the gate driving circuit unit can control the pre-charging circuit through a clock signal, to write the first power supply voltage to the third node, thus the conduction and disconnection of the second input circuit can be controlled; furthermore, by connecting the control terminal of the first pull-down circuit to a third clock signal terminal, the gate driving circuit unit can control the first pull-down circuit through another clock signal. In this way, the gate driving circuit unit does not need to be cascaded, so that the gate driving circuit unit can work independently, so that the gate driving circuit using the gate driving circuit unit can randomly select a sub-pixel row. In this way, on the one hand, the gate driving circuit using the gate driving circuit unit can partially refresh the display screen without line-by-line scanning, thus the refresh rate is greatly improved; for example, in a case that only a partial region of the display screen needs to be refreshed, only the partial region of the display screen can be refreshed specifically, thus the refresh rate is greatly improved. On the other hand, the gate driving circuit using the gate driving circuit unit can output “random frame shift”, thus the compensation horizontal stripes can be effectively eliminated.

In some examples, as illustrated by FIG. 5, the gate driving circuit unit 100 further includes a first capacitor C1, which includes a first plate and a second plate, the first plate of the first capacitor C1 is connected with the second node Q1, and the second plate of the first capacitor C1 is connected with the output terminal of the output circuit 120. In this way, the first capacitor C1 can maintain the high level of the second node Q1.

In some examples, as illustrated by FIG. 5, the gate driving circuit unit 100 further includes a pull-down maintenance circuit 150 and a gating circuit 160; the pull-down maintenance circuit 150 includes a control terminal, an input terminal and an output terminal, the input terminal of the pull-down maintenance circuit 150 is connected with the third node P, the output terminal of the pull-down maintenance circuit 150 is connected with the second clock signal terminal CLKB; the gating circuit 160 includes an input terminal, an output terminal, and a plurality of gating sub-circuits 165 connected in parallel between the input terminal and the output terminal of the gating circuit 160; the input terminal of the gating circuit 160 is connected with the control terminal of the pull-down maintenance circuit 150, and the output terminal of the gating circuit 160 is connected with the third clock signal terminal CLKC.

As described above, as illustrated by FIG. 6, one of prerequisites for the gate driving circuit unit 100 to output the gate driving signal is that in the first stage, the third node P can be maintained at a high level. the input terminal of the pull-down maintenance circuit 150 is connected with the third node P, and the output terminal of the pull-down maintenance circuit 150 is connected with the second clock signal terminal CLKB, so that the potential of the third node P can be pulled down; at the same time, the input terminal of the gating circuit 160 is connected with the control terminal of the pull-down maintenance circuit 150, therefore, only in a case that the gating circuit 160 controls the pull-down maintenance circuit 150 to be disconnected, the gate driving circuit unit 100 can output the gate driving signal, in a case that the gating circuit 160 controls the pull-down maintenance circuit 150 to be conducted, the gate driving circuit unit 100 cannot output the gate driving signal. In this way, the gating circuit 160 can be used to control whether the corresponding gate driving circuit unit 100 outputs a gate driving signal. On the other hand, since the gating circuit 160 includes a plurality of gating sub-circuits 165 connected in parallel, digital driving can be achieved through the plurality of gating sub-circuits 165. For example, in a case that the plurality of gating sub-circuits 165 are all disconnected, the gating circuit 160 can control the pull-down maintenance circuit 150 to be disconnected, and the potential of the third node P is not pulled down.

In some examples, as illustrated by FIG. 5, each of the gating sub-circuits 165 includes a gating transistor, and the gating transistor includes a gate electrode, a first electrode, and a second electrode, the first electrode of the gating transistor is connected with the input terminal of the gating circuit 160, and the second electrode of the gate transistor is connected with the output terminal of the gating circuit 160.

In some examples, as illustrated by FIG. 5, the gating circuit 160 includes a first gating transistor T1, a second gating transistor T2, a third gating transistor T3, a fourth gating transistor T4, a fifth gating transistor T5, a sixth gating transistor T6, a seventh gating transistor T7, and an eighth gating transistor T8. A gate electrode of the first gating transistor T1, a gate electrode of the second gating transistor T2, a gate electrode of the third gating transistor T3, a gate electrode of the fourth gating transistor T4, a gate electrode of the fifth gating transistor T5, a gate electrode of the sixth gating transistor T6, a gate electrode of the seventh gating transistor T7 and a gate electrode of the eighth gating transistor T8 are connected with different gating signals D1, D2, D3, D4, D5, D6, D7 and D8 respectively, therefore, only in a case that the gating signals D1 to D8 are all at low level, the gating circuit 160 can control the pull-down maintenance circuit 150 to be disconnected, and the potential of the third node P is not pulled down. It should be noted that in a case that the gating circuit 160 includes eight gating sub-circuits 165, 2\hat{ }8=256 groups of gate driving circuit units 100 can work independently, each of the gate driving circuit unit groups may include four gate driving circuit units, so that 1024 gate driving circuit units 100 can be achieved, that is, 1024 rows of sub-pixels can work independently, if the number of rows is to be increased, it is only needed to increase the number of the gating sub-circuits.

In some examples, as illustrated by FIG. 5, the pull-down maintenance circuit 150 includes a first pull-down maintenance transistor T9 and a second pull-down maintenance transistor T10, the first pull-down maintenance transistor T9 includes a gate electrode, a first electrode, and a second electrode, and the second pull-down maintenance transistor T10 includes a gate electrode, a first electrode, and a second electrode; the first electrode of the first pull-down maintenance transistor T9 is connected with the third node P, the output terminal of the first pull-down maintenance transistor T9 is connected with the input terminal of the second pull-down maintenance transistor T10, and the output terminal of the second pull-down maintenance transistor T10 is connected with the second clock signal terminal CLKB. In this way, the pull-down maintenance circuit 150 can pull down a potential of the third node P through the first pull-down maintenance transistor T9 and the second pull-down maintenance transistor T10, and can also prevent leakage current from occurring after the transistor is conductive due to long-term bias by setting the first pull-down maintenance transistor T9 and the second pull-down maintenance transistor T10, so that the reliability and service life of the gate driving circuit unit are improved.

For example, the first pull-down maintenance transistor T9 and the second pull-down maintenance transistor T10 may be oxide semiconductor transistors, so as to have a higher on-state current, thereby improving the pull-down performance and efficiency. It should be noted that, the above-mentioned oxide semiconductor transistor refers to a transistor whose semiconductor layer is made of oxide semiconductor material, and the oxide semiconductor material may include indium gallium zinc oxide (IGZO).

In some examples, as illustrated by FIG. 5, the first pull-down circuit 141 includes a first pull-down transistor T11 and a second pull-down transistor T12, the first pull-down transistor T11 includes a gate electrode, a first electrode, and a second electrode, the second pull-down transistor T12 includes a gate electrode, a first electrode and a second electrode; the first electrode of the first pull-down transistor T11 is connected with the second node Q1, the second electrode of the first pull-down transistor T11 is connected with the first electrode of the second pull-down transistor T12, and the second electrode of the second pull-down transistor T12 is connected with a second power supply voltage, such as VGL2. In this way, the first pull-down circuit can directly pull down the potential of the second node. Furthermore, since the first pull-down circuit 141 includes the first pull-down transistor T11 and the second pull-down transistor T12, the first pull-down circuit can avoid leakage current after the transistor is conductive due to long-term bias, and the reliability and service life of the gate driving circuit unit are improved. It should be noted that, the second power supply voltage is lower than the first power supply voltage.

For example, the first pull-down transistor T11 and the second pull-down transistor T12 may be oxide semiconductor transistors, so as to have a higher on-state current, so that the pull-down performance and efficiency are improved.

In some examples, as illustrated by FIG. 5, the control terminal of the first input circuit 111 is connected with the fourth clock signal terminal CLKD, which is configured to receive a fourth clock signal or be connected with a fourth clock signal line.

In some examples, as illustrated by FIG. 5, the first input circuit 111 includes a first input transistor T13, and the second input circuit 112 includes a second input transistor T14; the first input transistor T13 includes a gate electrode, a first electrode and a second electrode, and the second input transistor T14 includes a gate electrode, a first electrode and a second electrode; the first electrode of the first input transistor T13 is connected with the first power supply voltage, the second electrode of the first input transistor T13 and the first electrode of the second input transistor T14 are connected with a first node Q, and the second electrode of the second input transistor T14 is connected with the second node Q1. The gate electrode of the first input transistor T13 is connected with the fourth clock signal terminal CLKD, and the gate electrode of the second input transistor T14 is connected with the third node P.

In some examples, as illustrated by FIG. 5, the output circuit 120 includes an output transistor T15, which includes a gate electrode, a first electrode, and a second electrode, the gate electrode of the output transistor T15 is connected with the second node Q1, the first electrode of the output transistor T15 is connected with the first clock signal terminal CLKA, and the second electrode of the output transistor T15 serves as an output terminal of the output transistor 120.

In some examples, as illustrated by FIG. 5, the pre-charging circuit 130 includes a pre-charging transistor T16, which includes a gate electrode, a first electrode, and a second electrode, the gate electrode of the pre-charging transistor T16 is connected with the second clock signal terminal CLKB, the first electrode of the pre-charging transistor T16 is connected with the first power supply voltage, and the second electrode of the pre-charging transistor T16 is connected to the third node P. In this way, in a case that the signal on the second clock signal terminal CLKB is at a high level, the pre-charging transistor T16 can write the first power supply voltage connected with the first electrode into the third node P.

In some examples, as illustrated by FIG. 5, the pre-charging circuit 130 may further include a second capacitor C2, which includes a first plate and a second plate, the first electrode of the second capacitor C2 is connected with the first electrode of the pre-charging transistor T16, and the second electrode of the second capacitor C2 is connected with the second electrode of the pre-charging transistor T16, thus the second capacitor C2 can be used to maintain the potential on the third node P.

In some examples, as illustrated by FIG. 5, the gate driving circuit unit 100 further includes an inverter module 210; the inverter module 210 includes a control terminal and an output terminal, the control terminal of the inverter module 210 is connected to the second node Q1, and the output terminal of the inverter module 210 is connected to the fourth node QB, in this way, in a case that the second node Q1 is at a high level, the fourth node QB is at a low level, and in a case that the second node Q1 is at a low level, the fourth node QB is at a high level.

In some examples, as illustrated by FIG. 5, the gate driving circuit unit 100 further includes a first noise reduction circuit 181, which includes a control terminal, an input terminal, and an output terminal; the input terminal of the first noise reduction circuit 181 is connected to the first node Q, the control terminal of the first noise reduction circuit 181 is connected to the fourth node QB, and the output terminal of the first noise reduction circuit 181 is connected with the second power supply voltage, for example, VGL2. In this way, in a case that the fourth node QB is at a high level, the first noise reduction circuit 181 can reduce the noise of the first node Q, thus the reliability of the gate driving circuit unit can be improved.

In some examples, as illustrated by FIG. 5, the first noise reduction circuit 181 includes a first noise reduction transistor T17 and a second noise reduction transistor T18, the first noise reduction transistor T17 includes a gate electrode, a first electrode and a second electrode, and the second noise reduction transistor T18 includes a gate electrode, a first electrode and a second electrode; the first electrode of the first noise reduction transistor T17 is connected with the first node Q, and the second electrode of the first noise reduction transistor T17 is connected with the first electrode of the second noise reduction transistor T18, the second electrode of the second noise reduction transistor T18 is connected with the second power supply voltage, and the gate electrode of the first noise reduction transistor T17 and the gate electrode of the second noise reduction transistor T18 are connected with the fourth node QB.

In some examples, as illustrated by FIG. 5, the gate driving circuit unit 100 further includes a second pull-down circuit 142 and a third pull-down circuit 143; the second pull-down circuit 142 includes a control terminal, an input terminal and an output terminal, and the third pull-down circuit 143 includes a control terminal, an input terminal and an output terminal; the input terminal of the second pull-down circuit 142 is connected with the fourth node QB, and the output terminal of the second pull-down circuit 142 is connected with the input terminal of the third pull-down circuit 143, the output terminal of the third pull-down circuit 143 is connected with the second power supply voltage, the control terminal of the second pull-down circuit 142 is connected with the third node P, and the control terminal of the third pull-down circuit 143 is connected with the fourth clock signal terminal CLKD.

As illustrated by FIG. 6, in a case that the third node P is at a high level, the second pull-down circuit 142 is in a conducting state, and in a case that the third node P is at a low level, the second pull-down circuit 142 is in a disconnected state, therefore, in a case that the third node P is at a high level, the second pull-down circuit 142 can cooperate with the third pull-down circuit 143 to pull down the potential of the fourth node QB. In this case, since the control terminal of the third pull-down circuit 143 is connected with the fourth clock signal terminal CLKD, which is connected with a same clock signal as the control terminal of the first input circuit 111, the potential of the fourth node QB can be pulled down while the first input circuit 111 is turned on, thus the potential of the fourth node QB is quickly lowered, the reaction speed is improved, and the driving power consumption of the gate driving circuit unit is reduced. It should be noted that if the potential of the fourth node QB is not pulled down in time, leakage current will be generated from the first node Q to the first noise reduction circuit 181, resulting in increased driving power consumption.

In some examples, as illustrated by FIG. 5, the second pull-down circuit 142 includes a third pull-down transistor T19, which includes a gate electrode, a first electrode, and a second electrode; the third pull-down circuit 143 includes a fourth pull-down transistor T20, which includes a gate electrode, a first electrode, and a second electrode; the first electrode of the third pull-down transistor T19 is connected with the fourth node QB, the second electrode of the third pull-down transistor T19 is connected with the first electrode of the fourth pull-down transistor T20, the second electrode of the fourth pull-down transistor T20 is connected with the second power supply voltage, such as VGL2, the gate electrode of the third pull-down transistor T19 is connected with the third node P, and the gate electrode of the fourth pull-down transistor T20 is connected with the fourth clock signal terminal CLKD.

In some examples, as illustrated by FIG. 5, the gate driving circuit unit 100 further includes a second noise reduction circuit 182, which includes a control terminal, an input terminal, and an output terminal; the input terminal of the second noise reduction circuit 182 is connected with the second node Q1, the output terminal of the second noise reduction circuit 182 is connected with the second power supply voltage, such as VGL2, and the control terminal of the second noise reduction circuit 182 is connected with the fourth node QB. In this way, the second noise reduction circuit 182 can reduce the noise of the second node Q1 in response to the signal on the fourth node QB, thus the performance of the gate driving circuit unit 100 can be improved.

In some examples, as illustrated by FIG. 5, the second noise reduction circuit 182 includes a third noise reduction transistor T21 and a fourth noise reduction transistor T22, the third noise reduction transistor T21 includes a gate electrode, a first electrode and a second electrode, and the fourth noise reduction transistor T22 includes a gate electrode, a first electrode and a second electrode; the first electrode of the third noise reduction transistor T21 is connected with the second node Q1, the second electrode of the third noise reduction transistor T21 is connected with the first electrode of the fourth noise reduction transistor T22, the second electrode of the fourth noise reduction transistor T22 is connected with the second power supply voltage, for example, VGL2, and the gate electrode of the third noise reduction transistor T21 and the gate electrode of the fourth noise reduction transistor T22 are connected with the fourth node QB. In this way, in a case that the fourth node QB is at a high level, the third noise reduction transistor T21 and the fourth noise reduction transistor T22 may be conducted, thus the second power supply voltage is used to reduce noise at the second node Q1.

For example, the third noise reduction transistor T21 and the fourth noise reduction transistor T22 may both be oxide semiconductor transistors, so that the noise reduction capability of the second noise reduction circuit may be improved by utilizing the large on-state current of the oxide semiconductor transistors. In addition, since the second noise reduction circuit includes the third noise reduction transistor and the fourth noise reduction transistor, the second noise reduction circuit can also prevent leakage current from occurring after the transistors are conductive due to long-term bias, thus the reliability and service life of the gate driving circuit unit can be improved.

In some examples, as illustrated by FIG. 5, the gate driving circuit unit 100 further includes a third noise reduction circuit 183, which includes a control terminal, an input terminal, and an output terminal; the input terminal of the third noise reduction circuit 183 is connected with the output terminal of the output circuit 120, the output terminal of the third noise reduction circuit 183 is connected with a third power supply voltage, such as VGL1, and the control terminal of the third noise reduction circuit 183 is connected with the fourth node QB. In this way, the third noise reduction circuit 183 can respond to a signal on the fourth node QB, and perform noise reduction on the output terminal of the output circuit 120 through the third power supply voltage.

For example, the third power supply voltage and the second power supply voltage may be the same or different. The third power supply voltage and the second power supply voltage are both lower than the first power supply voltage.

In some examples, as illustrated by FIG. 5, the third noise reduction circuit 183 includes a fifth noise reduction transistor T23, which includes a gate electrode, a first electrode, and a second electrode; the first electrode of the fifth noise reduction transistor T23 is connected with the output terminal of the output circuit 120, the second electrode of the fifth noise reduction transistor T23 is connected with a third power supply voltage, such as VGL1, and the gate electrode of the fifth noise reduction transistor T23 is connected with the fourth node QB. In this way, in a case that the fourth node QB is at a high level, the fifth noise reduction transistor T23 is conducted, thus the third power supply voltage can be used to reduce noise at the output terminal of the output circuit 120.

In some examples, as illustrated by FIG. 5, the gate driving circuit unit 100 further includes a global reset circuit 190, which includes a first reset sub-circuit 191 and a second reset sub-circuit 192; the first reset sub-circuit 191 includes a control terminal, an input terminal and an output terminal, and the second reset sub-circuit 192 includes a control terminal, an input terminal and an output terminal, the input terminal of the first reset sub-circuit 191 is connected with the third node P, and the output terminal of the first reset sub-circuit 191 is connected to the second power supply voltage, for example, VGL2; the input terminal of the second reset sub-circuit 192 is connected with the first power supply voltage, such as VGH1, and the output terminal of the second reset sub-circuit 192 is connected with the fourth node QB, the control terminal of the first reset sub-circuit 191 and the control terminal of the second reset sub-circuit 192 are both connected with the global reset signal TRS. In this way, the first reset sub-circuit 191 and the second reset sub-circuit 192 can simultaneously respond to the global reset signal TRS, to reset the third node P and the fourth node QB simultaneously.

In some examples, as illustrated by FIG. 5, the first reset sub-circuit 191 includes a first reset transistor T24 and a second reset transistor T25; the first reset transistor T24 includes a gate electrode, a first electrode and a second electrode, and the second reset transistor T25 includes a gate electrode, a first electrode and a second electrode; the first electrode of the first reset transistor T24 is connected with the third node P, the second electrode of the first reset transistor T24 is connected with the first electrode of the second reset transistor T25, and the second electrode of the second reset transistor T25 is connected with the second power supply voltage, such as VGL2; the gate electrode of the first reset transistor T24 and the gate electrode of the second reset transistor T25 are both connected with the global reset signal TRS. In this way, the first reset transistor T24 and the second reset transistor T25 may respond to the global reset signal TRS, to reset the third node P using the second power supply voltage.

In some examples, both the first reset transistor T24 and the second reset transistor T25 may be oxide semiconductor transistors, thus the reset capability of the first reset sub-circuit can be improved by utilizing the large on-state current of the oxide semiconductor transistor. In addition, since the first reset sub-circuit includes the first reset transistor and the second reset transistor, the first reset sub-circuit can also prevent leakage current from occurring after the transistor is conductive due to long-term bias, thus the reliability and service life of the gate driving circuit unit can be improved.

In some examples, the second reset sub-circuit 192 includes a third reset transistor T26, which includes a gate electrode, a first electrode, and a second electrode; the first electrode of the third reset transistor T26 is connected with the first power supply voltage, such as VGH1, the second electrode of the third reset transistor T26 is connected with the fourth node QB, and the gate electrode of the third reset transistor T26 is connected with the global reset signal TRS. In this way, the third reset transistor T26 may respond to the global reset signal TRS, to reset the fourth node QB with the first power supply voltage.

In some examples, as illustrated by FIG. 5, the gate driving circuit unit 100 further includes a first leakage protection circuit 171, which includes a control terminal, an input terminal, and an output terminal; the input terminal of the first leakage protection circuit 171 is connected with the first power supply voltage, and the output terminal of the first leakage protection circuit 171 is connected with at least one of the second electrode of the first pull-down transistor T11, the second electrode of the first noise reduction transistor T17, and the second electrode of the third noise reduction transistor T21, the control terminal of the first leakage protection circuit 171 is connected with the second node Q1. The first leakage prevention circuit 171 can respond to the signal on the second node Q1 to prevent at least one of the second electrode of the first pull-down transistor T11, the second electrode of the first noise reduction transistor T17, and the second electrode of the third noise reduction transistor T21 from being biased for a long time, thus at least one of the second electrode of the first pull-down transistor T11, the second electrode of the first noise reduction transistor T17, and the second electrode of the third noise reduction transistor T21 is prevented from leaking.

In some examples, as illustrated by FIG. 5, the output terminal of the first leakage protection circuit 171 is simultaneously connected with the second electrode of the first pull-down transistor T11, the second electrode of the first noise reduction transistor T17, and the second electrode of the third noise reduction transistor T21.

In some examples, as illustrated by FIG. 5, the first leakage protection circuit 171 includes a first leakage protection transistor T27, which includes a gate electrode, a first electrode, and a second electrode; the first electrode of the first leakage protection transistor T27 is connected with the first power supply voltage, the second electrode of the first leakage protection transistor T27 is connected with the second electrode of the first pull-down transistor T11, the second electrode of the first noise reduction transistor T17 and the second electrode of the third noise reduction transistor T21, and the gate electrode of the first leakage protection transistor T27 is connected with the second node Q1. In a case that the second node Q1 is at a high level, the first leakage protection transistor T27 conducts, which writes the first power supply voltage to the second electrode of the first pull-down transistor T11, the second electrode of the first noise reduction transistor T17, and the second electrode of the third noise reduction transistor T21, thereby avoiding long term bias of the first pull-down transistor T11, the first noise reduction transistor T17, and the third noise reduction transistor T21.

In some examples, as illustrated by FIG. 5, the gate driving circuit unit 100 further includes a second leakage protection circuit 172, which includes a control terminal, an input terminal, and an output terminal; the input terminal of the second leakage protection circuit 172 is connected with the first power supply voltage, the output terminal of the second leakage protection circuit 172 is connected with the second electrode of the first reset transistor T24, and the control terminal of the second leakage protection circuit 172 is connected with the third node P. In this way, the second leakage protection circuit 172 can respond to the signal on the third node P to prevent the first reset transistor T24 from being biased for a long time, thus leakage failure of the second electrode of the first reset transistor T24 is prevented.

In some examples, as illustrated by FIG. 5, the second leakage prevention circuit 172 includes a second leakage prevention transistor T28, which includes a gate electrode, a first electrode, and a second electrode; the first electrode of the second leakage protection transistor T28 is connected with the first power supply voltage, the second electrode of the second leakage protection transistor T28 is connected with the second electrode of the first reset transistor T24, and the gate electrode of the second leakage protection transistor T28 is connected with the third node P. In a case that the third node P is at a high level, the second leakage protection transistor T28 is conducted, and the first power supply voltage is written into the second electrode of the first reset transistor T24, thus the first reset transistor T24 can be prevented from being biased for a long time.

In some examples, as illustrated by FIG. 5, the inverter module 210 includes a first reverse transistor T29, a second reverse transistor T30, a third reverse transistor T31, and a fourth reverse transistor T32; the first reverse transistor T29 includes a gate electrode, a first electrode and a second electrode, the second reverse transistor T30 includes a gate electrode, a first electrode and a second electrode, the third reverse transistor T31 includes a gate electrode, a first electrode and a second electrode, and the fourth reverse transistor T32 includes a gate electrode, a first electrode and a second electrode; the first electrode of the first reverse transistor T29, the first electrode of the second reverse transistor T30, and the gate electrode of the second reverse transistor T30 are all connected with a fourth power supply voltage, such as VGH2, the gate electrode of the first reverse transistor T29 is connected with the second electrode of the second reverse transistor T30, and the second electrode of the first reverse transistor T29 is connected with the fourth node QB; the first electrode of the third reverse transistor T31 is connected with the fourth node QB, and the second electrode of the third reverse transistor T32 is connected with the second power supply voltage; the first electrode of the fourth reverse transistor T32 is connected with the gate electrode of the first reverse transistor T29 and the second electrode of the second reverse transistor T30, and the second electrode of the fourth reverse transistor T32 is connected with a fifth power supply voltage, such as VGL3; the gate electrode of the third reverse transistor T31 and the gate electrode of the fourth reverse transistor T33 are both connected with the second node Q1. In this way, the inverter module 210 can make the second node Q1 and the fourth node QB serve as inverters to each other.

For example, the fourth power supply voltage is greater than the fifth power supply voltage; the fourth power supply voltage may be the same as the first power supply voltage, and the fifth power supply voltage may be the same as the second power supply voltage.

In some examples, as illustrated by FIG. 5, the gate driving circuit unit 100 further includes a fourth noise reduction circuit 184, which includes a control terminal, an input terminal, and an output terminal; the input terminal of the fourth noise reduction circuit 184 is connected with the input terminal of the gating circuit 160 and the control terminal of the pull-down maintenance circuit 150, the output terminal of the fourth noise reduction circuit 184 is connected with the second power supply voltage, and the control terminal of the fourth noise reduction circuit 184 is connected with the second clock signal terminal, thus in response to the signal on the second clock signal terminal, the second power supply voltage can be used to reduce the noise of the input terminal of the gating circuit 160 and the control terminal of the pull-down maintenance circuit 150.

In some examples, as illustrated by FIG. 5, the fourth noise reduction circuit 184 includes a sixth noise reduction transistor T33, which includes a gate electrode, a first electrode, and a second electrode; the first electrode of the sixth noise reduction transistor T33 is connected with the input terminal of the gating circuit 160 and the control terminal of the pull-down maintenance circuit 150, the second electrode of the sixth noise reduction transistor T33 is connected with the second power supply voltage, and the gate electrode of the sixth noise reduction transistor T33 is connected with the second clock signal terminal, thus in response to the signal on the second clock signal terminal, the second power supply voltage can be used to reduce the noise of the input terminal of the gating circuit 160 and the control terminal of the pull-down maintenance circuit 150.

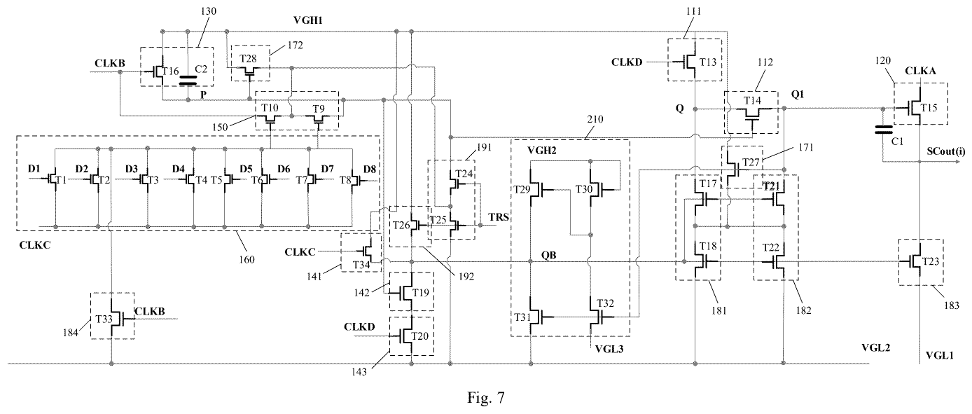

FIG. 7 is a schematic diagram of another gate driving circuit unit provided by an embodiment of the present disclosure. As illustrated by FIG. 7, different from the gate driving circuit unit shown in FIG. 5, the first pull-down circuit 141 is not directly connected with the second node Q1, but pulls down the potential of the second node Q1 through the fourth node QB and the first noise reduction circuit 181.

As illustrated by FIG. 7, the gate driving circuit unit 100 includes a first input circuit 111, a second input circuit 112, an output circuit 120, a pre-charging circuit 130, and a first pull-down circuit 141; the first input circuit 111 includes a control terminal, an input terminal and an output terminal, and the input terminal of the first input circuit 111 is connected with a first power supply voltage, such as VGH1; the second input circuit 112 includes a control terminal, an input terminal and an output terminal; the output circuit 120 includes a control terminal, an input terminal and an output terminal, the input terminal of the output circuit 120 is connected with the first clock signal terminal CLKA, which is configured to receive the first clock signal or be connected with the first clock signal line; the pre-charging circuit 130 includes a control terminal, an input terminal and an output terminal, the control terminal of the pre-charging circuit 130 is connected with the second clock signal terminal CLKB, which is configured to receive the second clock signal or be connected with the second clock signal line; the input terminal of the pre-charging circuit 130 is connected with a first power supply voltage, such as VGH1.

As illustrated by FIG. 7, the first pull-down circuit 141 includes a control terminal, an input terminal, and an output terminal; the output terminal of the first input circuit 111 and the input terminal of the second input circuit 112 are connected to the first node Q, and the output terminal of the second input circuit 112 and the control terminal of the output circuit 120 are connected to the second node Q1, the output terminal of the pre-charging circuit 130 and the control terminal of the second input circuit 112 are connected with a third node P, the control terminal of the first pull-down circuit 141 is connected with the third clock signal terminal CLKC, and is configured to pull down the potential of the second node in response to a signal on the third clock signal terminal CLKC.

As illustrated by FIG. 7, the gate driving circuit unit 100 further includes an inverter module 210 and a first noise reduction circuit 181; the inverter module 210 includes a control terminal and an output terminal, the control terminal of the inverter module 210 is connected to the second node Q1, and the output terminal of the inverter module 210 is connected to the fourth node QB. In this way, in a case that the second node Q1 is at a high level, the fourth node QB is at a low level, and in a case that the second node Q1 is at a low level, the fourth node QB is at a high level. The first noise reduction circuit 181 includes a control terminal, an input terminal and an output terminal; the input terminal of the first noise reduction circuit 181 is connected with the first node Q, the control terminal of the first noise reduction circuit 181 is connected with the fourth node QB, and the output terminal of the first noise reduction circuit 181 is connected with the second power supply voltage. At this time, the input terminal of the first pull-down circuit 141 is connected with the first power supply voltage, and the output terminal of the first pull-down circuit 141 is connected with the fourth node QB. In this way, the first pull-down circuit 141 can respond to the signal on the third clock signal terminal CLKC to write the first power supply voltage into the fourth node QB, thus the first noise reduction circuit 181 is conducted, so that the potential on the second node Q1 is pulled down by the first noise reduction circuit 181.

In the gate driving circuit unit provided by the embodiment of the present disclosure, the control terminal of the first pull-down circuit can be connected with the third clock signal terminal to control the first pull-down circuit through the clock signal without cascading, thus the gate driving circuit unit can work independently, so that the gate driving circuit using the gate driving circuit unit can randomly select a certain sub-pixel row. In this way, on the one hand, the gate driving circuit using the gate driving circuit unit can partially refresh the display screen without line-by-line scanning, thus the refresh rate is greatly improved; for example, in a case that only a partial region of the display screen needs to be refreshed, only the partial region of the display screen can be refreshed specifically, thus the refresh rate can be greatly improved. On the other hand, the gate driving circuit using the gate driving circuit unit can output “random frame shift”, thus the compensation horizontal stripes can be effectively eliminated.

In some examples, as illustrated by FIG. 7, the gate driving circuit unit 100 further includes a pull-down maintenance circuit 150 and a gating circuit 160; the pull-down maintenance circuit 150 includes a control terminal, an input terminal and an output terminal, the input terminal of the pull-down maintenance circuit 150 is connected with the third node P, and the output terminal of the pull-down maintenance circuit 150 is connected with the second clock signal terminal CLKB; the gating circuit 160 includes an input terminal, an output terminal, and a plurality of gating sub-circuits 165 connected in parallel between the input terminal and the output terminal of the gating circuit 160; the input terminal of the gating circuit 160 is connected with the control terminal of the pull-down maintenance circuit 150, and the output terminal of the gating circuit 160 is connected with the third clock signal terminal CLKC. With reference to the descriptions of FIG. 5 and FIG. 6, the gating circuit 160 may be used to control whether the corresponding gate driving circuit unit 100 outputs a gate driving signal. On the other hand, since the gating circuit 160 includes the plurality of gating sub-circuits 165 connected in parallel, digital driving can be achieved through the plurality of gating sub-circuits 165. For example, in a case that the plurality of gating sub-circuits 165 are all disconnected, the gating circuit 160 can control the pull-down maintenance circuit 150 to be disconnected, and the potential of the third node P is not pulled down.

In some examples, as illustrated by FIG. 7, the first pull-down circuit 141 includes a fifth pull-down transistor T34, which includes a gate electrode, a first electrode, and a second electrode; the first electrode of the fifth pull-down transistor T34 is connected with the first power supply voltage, the second electrode of the fifth pull-down transistor T34 is connected with the fourth node QB, and the gate electrode of the fifth pull-down transistor T34 is connected with the third clock signal terminal CLKC. In this way, in a case that the signal on the third clock signal terminal CLKC is at a high level, the fifth pull-down transistor T34 is conducted to write the first power supply voltage into the fourth node QB, thus the first noise reduction circuit 181 is conducted, so that the potential at the second node Q1 is pulled down by the first noise reduction circuit 181.

In some examples, as illustrated by FIG. 7, the gate driving circuit unit 100 further includes a second pull-down circuit 142 and a third pull-down circuit 143; the second pull-down circuit 142 includes a control terminal, an input terminal and an output terminal, and the third pull-down circuit 143 includes a control terminal, an input terminal and an output terminal; the input terminal of the second pull-down circuit 142 is connected with the fourth node QB, and the output terminal of the second pull-down circuit 142 is connected with the input terminal of the third pull-down circuit 143, the output terminal of the third pull-down circuit 143 is connected with the second power supply voltage, the control terminal of the second pull-down circuit 142 is connected with the third node P, and the control terminal of the third pull-down circuit 143 is connected with the fourth clock signal terminal CLKD.

As illustrated by FIG. 7, in a case that the third node P is at a high level, the second pull-down circuit 142 is in a conducting state, and in a case that the third node P is at a low level, the second pull-down circuit 142 is in a disconnected state, therefore, in a case that the third node P is at a high level, the second pull-down circuit 142 can cooperate with the third pull-down circuit 143 to pull down the potential of the fourth node QB. In this case, since the control terminal of the third pull-down circuit 143 is connected with the fourth clock signal terminal CLKD, which is connected with a same clock signal as the control terminal of the first input circuit 111, the potential of the fourth node QB can be pulled down while the first input circuit 111 is conducted, thus the potential of the fourth node QB is quickly lowered, the reaction speed is improved, and the driving power consumption of the gate driving circuit unit is reduced. It should be noted that if the potential of the fourth node QB is not pulled down in time, leakage current will be generated from the first node Q to the first noise reduction circuit 181, resulting in increased driving power consumption.

In some examples, as illustrated by FIG. 7, the second pull-down circuit 142 includes a third pull-down transistor T19, which includes a gate electrode, a first electrode, and a second electrode; the third pull-down circuit 143 includes a fourth pull-down transistor T20, which includes a gate electrode, a first electrode, and a second electrode; the first electrode of the third pull-down transistor T19 is connected with the fourth node QB, the second electrode of the third pull-down transistor T19 is connected with the first electrode of the fourth pull-down transistor T20, the second electrode of the fourth pull-down transistor T20 is connected with the second power supply voltage, such as VGL2, the gate electrode of the third pull-down transistor T19 is connected with the third node P, and the gate electrode of the fourth pull-down transistor T20 is connected with the fourth clock signal terminal CLKD.

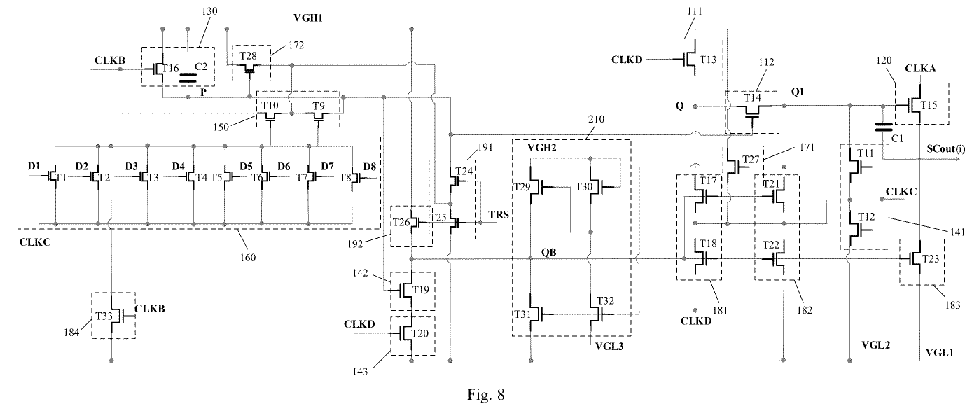

FIG. 8 is a schematic diagram of another gate driving circuit unit provided by an embodiment of the present disclosure. As illustrated by FIG. 8, different from the gate driving circuit unit shown in FIG. 5, the output terminal of the first noise reduction circuit 181 is not connected with the second power supply voltage, but is connected with the fourth clock signal terminal CLKD.

As illustrated by FIG. 8, the gate driving circuit unit 100 includes a first input circuit 111, a second input circuit 112, an output circuit 120, a pre-charging circuit 130, and a first pull-down circuit 141; the first input circuit 111 includes a control terminal, an input terminal and an output terminal, and the input terminal of the first input circuit 111 is connected with a first power supply voltage, such as VGH1; the second input circuit 112 includes a control terminal, an input terminal and an output terminal; the output circuit 120 includes a control terminal, an input terminal and an output terminal; the input terminal of the output circuit 120 is connected with a first clock signal terminal CLKA, which is configured to receive the first clock signal or be connected with the first clock signal line; the pre-charging circuit 130 includes a control terminal, an input terminal and an output terminal, the control terminal of the pre-charging circuit 130 is connected with the second clock signal terminal CLKB, which is configured to receive the second clock signal or be connected with the second clock signal line; and the input terminal of the pre-charging circuit 130 is connected with a first power supply voltage, such as VGH1.

As illustrated by FIG. 8, the first pull-down circuit 141 includes a control terminal, an input terminal and an output terminal; the output terminal of the first input circuit 111 and the input terminal of the second input circuit 112 are connected with the first node Q, the output terminal of the second input circuit 112 and the control terminal of the output circuit 120 are connected with the second node Q1, and the output terminal of the pre-charging circuit 130 and the control terminal of the second input circuit 112 are connected with the third node P, the control terminal of the first pull-down circuit 141 is connected with the third clock signal terminal CLKC, and is configured to pull down the potential of the second node in response to a signal on the third clock signal terminal CLKC.

In the gate driving circuit unit provided by the embodiment of the present disclosure, the control terminal of the first pull-down circuit can be connected with the third clock signal terminal, to control the first pull-down circuit through the clock signal without cascading, thus the gate driving circuit unit can work independently, so that the gate driving circuit using the gate driving circuit unit can randomly select a certain sub-pixel row. In this way, on the one hand, the gate driving circuit using the gate driving circuit unit can partially refresh the display screen without line-by-line scanning, thus the refresh rate is greatly improved; for example, in a case that only a partial region of the display screen needs to be refreshed, only the partial region of the display screen can be refreshed specifically, the refresh rate can be greatly improved. On the other hand, the gate driving circuit using the gate driving circuit unit can output “random frame shift”, thus the compensation horizontal stripes can be effectively eliminated.

As illustrated by FIG. 8, the gate driving circuit unit 100 further includes an inverter module 210 and a first noise reduction circuit 181; the inverter module 210 includes a control terminal and an output terminal, the control terminal of the inverter module 210 is connected with the second node Q1, and the output terminal of the inverter module 210 is connected with the fourth node QB, in this way, in a case that the second node Q1 is at a high level, the fourth node QB is at a low level, and in a case that the second node Q1 is at a low level, the fourth node QB is at a high level. The first noise reduction circuit 181 includes a control terminal, an input terminal and an output terminal; the input terminal of the first noise reduction circuit 181 is connected with the first node Q, the control terminal of the first noise reduction circuit 181 is connected with the fourth node QB, and the output terminal of the first noise reduction circuit 181 is connected with the fourth clock signal terminal CLKD. In this way, in a case that the fourth node QB is at a high level, the first noise reduction circuit 181 can use the signal on the fourth clock signal terminal CLKD to reduce the noise of the first node Q, thus the reliability of the gate driving circuit unit can be improved.

In some examples, as illustrated by FIG. 8, the first noise reduction circuit 181 includes a first noise reduction transistor T17 and a second noise reduction transistor T18, the first noise reduction transistor T17 includes a gate electrode, a first electrode and a second electrode, and the second noise reduction transistor T18 includes a gate electrode, a first electrode and a second electrode; the first electrode of the first noise reduction transistor T17 is connected with the first node Q, and the second electrode of the first noise reduction transistor T17 is connected with the first electrode of the second noise reduction transistor T18, the second electrode of the second noise reduction transistor T18 is connected with the fourth clock signal terminal CLKD, and the gate electrode of the first noise reduction transistor T17 and the gate electrode of the second noise reduction transistor T18 are connected with the fourth node QB.

In some examples, as illustrated by FIG. 8, the gate driving circuit unit 100 further includes a pull-down maintenance circuit 150 and a gating circuit 160; the pull-down maintenance circuit 150 includes a control terminal, an input terminal and an output terminal; the input terminal of the pull-down maintenance circuit 150 is connected with the third node P, and the output terminal of the pull-down maintenance circuit 150 is connected with the second clock signal terminal CLKB; the gating circuit 160 includes an input terminal, an output terminal and a plurality of gating sub-circuits 165 connected in parallel between the input terminal and the output terminal of the gating circuit 160; the input terminal of the gating circuit 160 is connected with the control terminal of the pull-down maintenance circuit 150, and the output terminal of the gating circuit 160 is connected with the third clock signal terminal CLKC. With reference to the descriptions of FIG. 5 and FIG. 6, the gating circuit 160 may be used to control whether the corresponding gate driving circuit unit 100 outputs a gate driving signal. On the other hand, since the gating circuit 160 includes the plurality of gating sub-circuits 165 connected in parallel, digital driving can be achieved by the plurality of gating sub-circuits 165. For example, in a case that the plurality of gating sub-circuits 165 are disconnected, the gating circuit 160 can control the pull-down maintenance circuit 150 to be disconnected, and the potential of the third node P is not pulled down.

In some examples, as illustrated by FIG. 8, the gate driving circuit unit 100 further includes a second pull-down circuit 142 and a third pull-down circuit 143; the second pull-down circuit 142 includes a control terminal, an input terminal and an output terminal, and the third pull-down circuit 143 includes a control terminal, an input terminal and an output terminal; the input terminal of the second pull-down circuit 142 is connected with the fourth node QB, the output terminal of the second pull-down circuit 142 is connected with the input terminal of the third pull-down circuit 143, and the output terminal of the third pull-down circuit 143 is connected with the second power supply voltage, the control terminal of the second pull-down circuit 142 is connected with the third node P, and the control terminal of the third pull-down circuit 143 is connected with the fourth clock signal terminal CLKD.

As illustrated by FIG. 8, in a case that the third node P is at a high level, the second pull-down circuit 142 is in a conducting state, and in a case that the third node P is at a low level, the second pull-down circuit 142 is in a disconnected state, therefore, in a case that the third node P is at a high level, the second pull-down circuit 142 can cooperate with the third pull-down circuit 143 to pull down the potential of the fourth node QB. In this case, since the control terminal of the third pull-down circuit 143 is connected with the fourth clock signal terminal CLKD, which is connected with a same clock signal as the control terminal of the first input circuit 111, the potential of the fourth node QB can be pulled down while the first input circuit 111 is conducted, thus the potential of the fourth node QB is quickly lowered, the reaction speed is improved, and the driving power consumption of the gate driving circuit unit is reduced. It should be noted that, if the potential of the fourth node QB is not pulled down in time, leakage current will be generated from the first node Q to the first noise reduction circuit 181, resulting in increased driving power consumption.

In some examples, as illustrated by FIG. 8, the second pull-down circuit 142 includes a third pull-down transistor T19, which includes a gate electrode, a first electrode, and a second electrode; the third pull-down circuit 143 includes a fourth pull-down transistor T20, which includes a gate electrode, a first electrode, and a second electrode; the first electrode of the third pull-down transistor T19 is connected with the fourth node QB, the second electrode of the third pull-down transistor T19 is connected with the first electrode of the fourth pull-down transistor T20, and the second electrode of the fourth pull-down transistor T20 is connected with the second power supply voltage, such as VGL2, the gate electrode of the third pull-down transistor T19 is connected with the third node P, and the gate electrode of the fourth pull-down transistor T20 is connected with the fourth clock signal terminal CLKD.

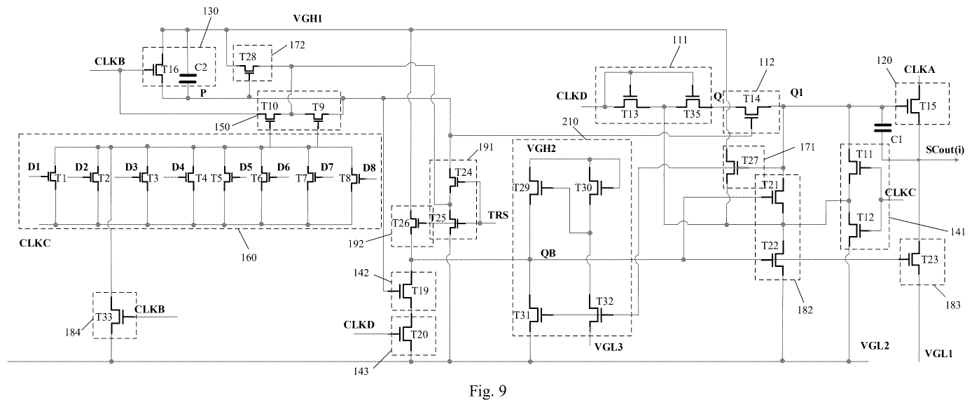

FIG. 9 is a schematic diagram of another gate driving circuit unit provided by an embodiment of the present disclosure. As illustrated by FIG. 9, different from the gate driving circuit unit shown in FIG. 5, the first input circuit 111 adopts a dual-transistor structure, and the first node Q is not arranged with a first noise reduction circuit for noise reduction. In this way, the gate driving circuit unit can effectively reduce a risk of leakage current in the first input circuit 111 in a case that the fourth node QB is at a high level.

As illustrated by FIG. 9, the gate driving circuit unit 100 includes a first input circuit 111, a second input circuit 112, an output circuit 120, a pre-charging circuit 130, and a first pull-down circuit 141; the first input circuit 111 includes a control terminal, an input terminal and an output terminal, and the input terminal of the first input circuit 111 is connected with a first power supply voltage, such as VGH1; the second input circuit 112 includes a control terminal, an input terminal and an output terminal; the output circuit 120 includes a control terminal, an input terminal and an output terminal, the input terminal of the output circuit 120 is connected with the first clock signal terminal CLKA, which is configured to receive the first clock signal or is connected with the first clock signal line; the pre-charging circuit 130 includes a control terminal, an input terminal and an output terminal, the control terminal of the pre-charging circuit 130 is connected with the second clock signal terminal CLKB, which is configured to receive the second clock signal or be connected with the second clock signal line; the input terminal of the pre-charging circuit 130 is connected with a first power supply voltage, such as VGH1.

As illustrated by FIG. 9, the first pull-down circuit 141 includes a control terminal, an input terminal and an output terminal; the output terminal of the first input circuit 111 and the input terminal of the second input circuit 112 are connected with the first node Q, the output terminal of the second input circuit 112 and the control terminal of the output circuit 120 are connected with the second node Q1, and the output terminal of the pre-charging circuit 130 and the control terminal of the second input circuit 112 are connected with the third node P, the control terminal of the first pull-down circuit 141 is connected with the third clock signal terminal CLKC, and is configured to pull down the potential of the second node in response to a signal on the third clock signal terminal CLKC.

In the gate driving circuit unit provided by the embodiment of the present disclosure, the control terminal of the first pull-down circuit can be connected with the third clock signal terminal, to control the first pull-down circuit through the clock signal without cascading, thus the gate driving circuit unit can work independently, so that the gate driving circuit using the gate driving circuit unit can randomly select a certain sub-pixel row. In this way, on the one hand, the gate driving circuit using the gate driving circuit unit can partially refresh the display screen without line-by-line scanning, thus the refresh rate is greatly improved; for example, in a case that only a part of the displayed image needs to be refreshed, only the part of the displayed image can be refreshed specifically, thus the refresh rate can be greatly improved. On the other hand, the gate driving circuit using the gate driving circuit unit can output “random frame shift”, thus, the compensation horizontal stripes can be effectively eliminated.

As illustrated by FIG. 9, the gate driving circuit unit 100 further includes an inverter module 210; the inverter module 210 includes a control terminal and an output terminal, the control terminal of the inverter module 210 is connected with the second node Q1, and the output terminal of the inverter module 210 is connected with the fourth node QB. In this way, in a case that the second node Q1 is at a high level, the fourth node QB is at a low level, and in a case that the second node Q1 is at a low level, the fourth node QB is at a high level.

As illustrated by FIG. 9, the first input circuit 111 includes a first input transistor T13 and a third input transistor T35, and the second input circuit 112 includes a second input transistor T14; the first input transistor T13 includes a gate electrode, a first electrode and a second electrode, the second input transistor T14 includes a gate electrode, a first electrode and a second electrode, and the third input transistor T35 includes a gate electrode, a first electrode and a second electrode; the second electrode of the first input transistor T13 is connected with the first electrode of the third input transistor T35, and the first electrode of the first input transistor T13, the gate electrode of the first input transistor T13, and the gate electrode of the third input transistor T35 are connected with the fourth clock signal terminal CLKD, the second electrode of the third input transistor T35 and the first electrode of the second input transistor T14 are connected with the first node Q, and the gate electrode of the second input transistor T14 is connected with the third node P. In this way, the gate driving circuit unit 100 can effectively reduce the risk of leakage current in the first input circuit in a case that the fourth node is at a high level.

In some examples, the first input transistor T13 and the third input transistor T35 may both be oxide semiconductor transistors, thus the input performance of the first input circuit can be improved by utilizing the large on-state current characteristic of the oxide semiconductor transistor.

In some examples, as illustrated by FIG. 9, the input terminal of the first leakage protection circuit 171 is connected with the first power supply voltage, the output terminal of the first leakage protection circuit 171 is also connected with the second electrode of the first input transistor T13, and the control terminal of the first leakage protection circuit 171 is connected with the second node Q1. The first leakage protection circuit 171 can respond to the signal on the second node Q1 to prevent the first input transistor T13 from being biased for a long time, thus leakage current of the first input transistor T13 is prevented.

In some examples, as illustrated by FIG. 9, the output terminal of the first leakage protection circuit 171 is also connected with the second electrode of the first pull-down transistor T11 and the second electrode of the third noise reduction transistor T21.

In some examples, as illustrated by FIG. 9, the first leakage protection circuit 171 includes a first leakage protection transistor T27, which includes a gate electrode, a first electrode, and a second electrode; the first electrode of the first leakage protection transistor T27 is connected with the first power supply voltage, the second electrode of the first leakage protection transistor T27 is connected with the second electrode of the first pull-down transistor T11, the second electrode of the first input transistor T13 is connected with the second electrode of the third noise reduction transistor T21, and the gate electrode of the first leakage protection transistor T27 is connected with the second node Q1. In a case that the second node Q1 is at a high level, the first leakage protection transistor T27 is conducted, and the first power supply voltage is written into the second electrode of the first pull-down transistor T11, the second electrode of the first input transistor T13, and the second electrode of the third noise reduction transistor T21, thus the first pull-down transistor T11, the first input transistor T13 and the third noise reduction transistor T21 can be prevented from being biased for a long time.

In some examples, as illustrated by FIG. 9, the gate driving circuit unit 100 further includes a pull-down maintenance circuit 150 and a gating circuit 160; the pull-down maintenance circuit 150 includes a control terminal, an input terminal and an output terminal, the input terminal of the pull-down maintenance circuit 150 is connected with the third node P, and the output terminal of the pull-down maintenance circuit 150 is connected with the second clock signal terminal CLKB; the gating circuit 160 includes an input terminal, an output terminal, and a plurality of gating sub-circuits 165 connected in parallel between the input terminal and the output terminal of the gating circuit 160; the input terminal of the gating circuit 160 is connected with the control terminal of the pull-down maintenance circuit 150, and the output terminal of the gating circuit 160 is connected with the third clock signal terminal CLKC. With reference to the descriptions of FIG. 5 and FIG. 6, the gating circuit 160 may be used to control whether the corresponding gate driving circuit unit 100 outputs a gate driving signal. On the other hand, since the gating circuit 160 includes a plurality of gating sub-circuits 165 connected in parallel, digital driving can be achieved through the plurality of gating sub-circuits 165. For example, in a case that the plurality of gating sub-circuits 165 are all disconnected, the gating circuit 160 can control the pull-down maintenance circuit 150 to be disconnected, and the potential of the third node P is not pulled down.

In some examples, as illustrated by FIG. 9, the gate driving circuit unit 100 further includes a second pull-down circuit 142 and a third pull-down circuit 143; the second pull-down circuit 142 includes a control terminal, an input terminal and an output terminal, and the third pull-down circuit 143 includes a control terminal, an input terminal and an output terminal; the input terminal of the second pull-down circuit 142 is connected with the fourth node QB, and the output terminal of the second pull-down circuit 142 is connected with the input terminal of the third pull-down circuit 143. The output terminal of the third pull-down circuit 143 is connected with the second power supply voltage, the control terminal of the second pull-down circuit 142 is connected with the third node P, and the control terminal of the third pull-down circuit 143 is connected with the fourth clock signal terminal CLKD.

As illustrated by FIG. 9, in a case that the third node P is at a high level, the second pull-down circuit 142 is in a conducting state, and in a case that the third node P is at a low level, the second pull-down circuit 142 is in a disconnected state, therefore, in a case that the third node P is at a high level, the second pull-down circuit 142 can cooperate with the third pull-down circuit 143 to pull down the potential of the fourth node QB. In this case, since the control terminal of the third pull-down circuit 143 is connected with the fourth clock signal terminal CLKD, which is connected with a same clock signal as the control terminal of the first input circuit 111, the potential of the fourth node QB can be pulled down while the first input circuit 111 is conducted, thus the potential of the fourth node QB is quickly lowered, the reaction speed is improved, and the driving power consumption of the gate driving circuit unit is reduced. It should be noted that if the potential of the fourth node QB is not pulled down in time, leakage current will be generated from the first node Q to the first noise reduction circuit 181, resulting in increased driving power consumption.

In some examples, as illustrated by FIG. 9, the second pull-down circuit 142 includes a third pull-down transistor T19, which includes a gate electrode, a first electrode, and a second electrode; the third pull-down circuit 143 includes a fourth pull-down transistor T20, which includes a gate electrode, a first electrode, and a second electrode; the first electrode of the third pull-down transistor T19 is connected with the fourth node QB, the second electrode of the third pull-down transistor T19 is connected with the first electrode of the fourth pull-down transistor T20, and the second electrode of the fourth pull-down transistor T20 is connected with the second power supply voltage, such as VGL2, the gate electrode of the third pull-down transistor T19 is connected with the third node P, and the gate electrode of the fourth pull-down transistor T20 is connected with the fourth clock signal terminal CLKD.

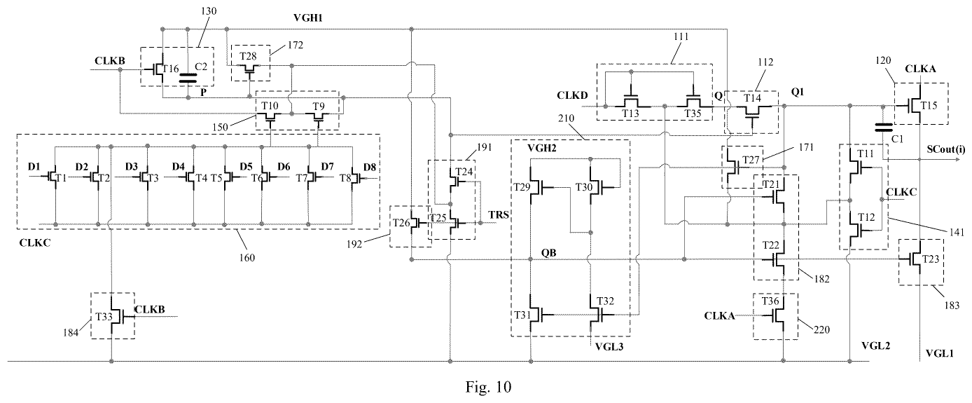

FIG. 10 is a schematic diagram of another gate driving circuit unit provided by an embodiment of the present disclosure. As illustrated by FIG. 10, different from the gate driving circuit unit shown in FIG. 5, the gate driving circuit unit 100 does not have a second pull-down circuit 142 and a third pull-down circuit 143, but connects an isolation circuit 220 with the output terminal of the second noise reduction circuit 182, so that the potential of the second node Q1 will not be affected by the second power supply voltage, thus the output capacity is increased and the model power consumption is reduced, while the noise suppression capability of the first node Q is not affected.

As illustrated by FIG. 10, the gate driving circuit unit 100 includes a first input circuit 111, a second input circuit 112, an output circuit 120, a pre-charging circuit 130, and a first pull-down circuit 141; the first input circuit 111 includes a control terminal, an input terminal and an output terminal, and the input terminal of the first input circuit 111 is connected with a first power supply voltage, such as VGH1; the second input circuit 112 includes a control terminal, an input terminal and an output terminal; the output circuit 120 includes a control terminal, an input terminal and an output terminal, the input terminal of the output circuit 120 is connected with the first clock signal terminal CLKA, which is configured to receive the first clock signal or is connected with the first clock signal line; the pre-charging circuit 130 includes a control terminal, an input terminal and an output terminal, the control terminal of the pre-charging circuit 130 is connected with the second clock signal terminal CLKB, which is configured to receive the second clock signal or be connected to the second clock signal line; and the input terminal of the pre-charging circuit 130 is connected to a first power supply voltage, such as VGH1.

As illustrated by FIG. 10, the first pull-down circuit 141 includes a control terminal, an input terminal, and an output terminal; the output terminal of the first input circuit 111 and the input terminal of the second input circuit 112 are connected to the first node Q, and the output terminal of the second input circuit 112 and the control terminal of the output circuit 120 are connected to the second node Q1, the output terminal of the pre-charging circuit 130 and the control terminal of the second input circuit 112 are connected to the third node P, the control terminal of the first pull-down circuit 141 is connected with the third clock signal terminal CLKC, and is configured to respond to the signal on the third clock signal terminal CLKC, to pull down the potential of the second node.

In the gate driving circuit unit provided by the embodiment of the present disclosure, the control terminal of the first pull-down circuit can be connected with the third clock signal terminal, to control the first pull-down circuit through the clock signal without cascading, thus the gate driving circuit unit can work independently, so that the gate driving circuit using the gate driving circuit unit can randomly select a certain sub-pixel row. In this way, on the one hand, the gate driving circuit using the gate driving circuit unit can partially refresh the display screen without performing line-by-line scanning, thus the refresh rate is greatly improved; for example, in a case that only a partial region of the display screen needs to be refreshed, only the partial region of the display screen can be refreshed specifically, thus the refresh rate can be greatly improved. On the other hand, the gate driving circuit using the gate driving circuit unit can output “random frame shift”, thus the compensation horizontal stripes can be effectively eliminated.

As illustrated by FIG. 10, the gate driving circuit unit 100 further includes an inverter module 210; the inverter module 210 includes a control terminal and an output terminal, the control terminal of the inverter module 210 is connected to the second node Q1, and the output terminal of the inverter module 210 is connected to the fourth node QB, in this way, in a case that the second node Q1 is at a high level, the fourth node QB is at a low level, and in a case that the second node Q1 is at a low level, the fourth node QB is at a high level.

As illustrated by FIG. 10, the gate driving circuit unit 100 further includes a second noise reduction circuit 182 and an isolation circuit 220, and the second noise reduction circuit 182 includes a control terminal, an input terminal, and an output terminal; the isolation circuit 220 includes a control terminal, an input terminal and an output terminal; the input terminal of the second noise reduction circuit 182 is connected with the second node Q1, and the output terminal of the second noise reduction circuit 182 is connected with the input terminal of the isolation circuit 220, the control terminal of the second noise reduction circuit 182 is connected with the fourth node QB, the output terminal of the isolation circuit 220 is connected with a second power supply voltage, such as VGL2, and the control terminal of the isolation circuit 220 is connected with the first clock signal terminal CLKA. In this way, in a case that the first clock signal terminal CLKA is at a high level, the second noise reduction circuit 182 can reduce the noise of the second node Q1 in response to the signal on the fourth node QB, thus the performance of the gate driving circuit unit 100 can be improved, in a case that the first clock signal terminal CLKA is at a low level, the isolation circuit 220 can isolate the second node Q1 from the second power supply voltage, so that the potential of the second node Q1 will not be affected by the second power supply voltage, thus the output capacity is increased, the power consumption of the model is reduced, and the noise suppression capability of the first node Q is not affected.

In some examples, as illustrated by FIG. 10, the second noise reduction circuit 182 includes a third noise reduction transistor T21 and a fourth noise reduction transistor T22, the third noise reduction transistor T21 includes a gate electrode, a first electrode and a second electrode, the fourth noise reduction transistor T22 includes a gate electrode, a first electrode and a second electrode; the isolation circuit 220 includes an isolation transistor T36, which includes a gate electrode, a first electrode, and a second electrode. The first electrode of the third noise reduction transistor T21 is connected with the second node Q1, a second electrode of the third noise reduction transistor T21 is connected with the first electrode of the fourth noise reduction transistor T22, the second electrode of the fourth noise reduction transistor T22 is connected with the first electrode of the isolation transistor T36, and the second electrode of the isolation transistor T36 is connected with a second power supply voltage, such as VGL2; the gate electrode of the third noise reduction transistor T21 and the gate electrode of the fourth noise reduction transistor T22 are connected with the fourth node QB, and the gate electrode of the isolation transistor T36 is connected with the first clock signal terminal CLKA.

For example, the third noise reduction transistor T21 and the fourth noise reduction transistor T22 may both be oxide semiconductor transistors, thus the characteristic of large on-state current of the oxide semiconductor transistor can be utilized to enhance the noise reduction capability of the second noise reduction circuit. In addition, since the second noise reduction circuit includes the third noise reduction transistor and the fourth noise reduction transistor, the second noise reduction circuit can also prevent leakage current from occurring after the transistors are conductive due to long-term bias, thus the reliability and service life of the gate driving circuit unit can be improved.

It should be noted that, the transistors in the above embodiments may all be thin film transistors or field effect transistors or other switching devices with the same characteristics; the transistors in the above embodiments may all be oxide transistors. Taking a thin film transistor as an example, an active layer (a channel region) of the transistor is made of oxide semiconductor materials, such as indium gallium tin oxide (IGZO), while a gate electrode, a source electrode and a drain electrode of the transistor are made of metal materials, such as metal aluminum or aluminum alloy. The source electrode and the drain electrode of the transistor used herein may be symmetrical in structure, so there may be no difference in structure between the source electrode and the drain electrode. In the embodiments of the present disclosure, in order to distinguish the two electrodes of the transistor except the gate electrode, one of the electrodes is directly described as a first electrode and the other electrode is directly described as a second electrode.

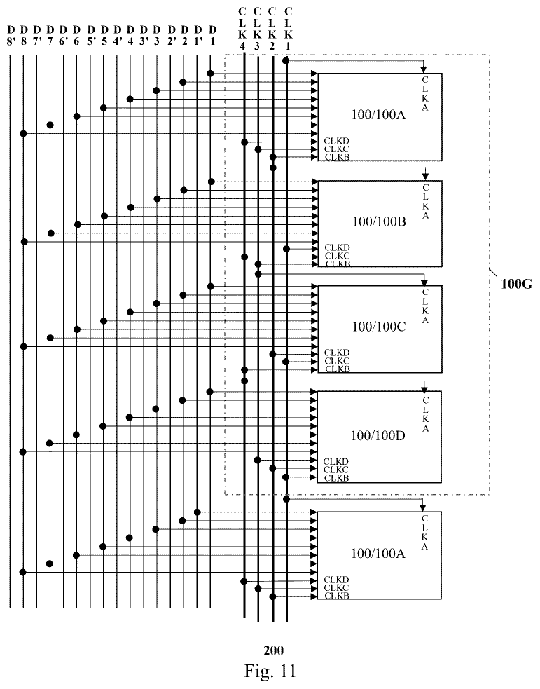

At least one embodiment of the present disclosure further provides a gate driving circuit. FIG. 11 is a schematic diagram of a gate driving circuit provided by an embodiment of the present disclosure. As illustrated by FIG. 11, each gate driving circuits 200 includes a gate driving circuit unit 100 provided by any one of the above examples. In this way, the gate driving circuit 200 can partially refresh the display screen without scanning line by line, thus the refresh rate is greatly improved; for example, in a case that only a partial region of the display screen needs to be refreshed, only the partial region of the display screen may be refreshed specifically, thus the refresh rate can be greatly improved. On the other hand, the gate driving circuit 200 can output “random frame shift”, thus the compensation horizontal stripes can be effectively eliminated.

In some examples, as illustrated by FIG. 11, the plurality of gate driving circuit units 100 include a plurality of gate driving circuit unit groups 100G, each of the plurality of gate driving circuit unit groups 100G includes a first gate driving circuit unit 100A, a second gate driving circuit unit 100B, a third gate driving circuit unit 100C and a fourth gate driving circuit unit 100D; the first clock signal terminal CLKA of the first gate driving circuit unit 100A is connected with the first clock signal line CLK1, and the first clock signal terminal CLKA of the second gate driving circuit unit 100B is connected with the second clock signal line CLK2, the first clock signal terminal CLKA of the third gate driving circuit unit 100C is connected with the third clock signal line CLK3, and the first clock signal terminal CLKA of the fourth gate driving circuit unit 100D is connected with the fourth clock signal line CLK4. In this way, in a case that a gate driving circuit unit group is gated, the gate driving circuit unit group can output gate driving signals in sequence through the above connection method.

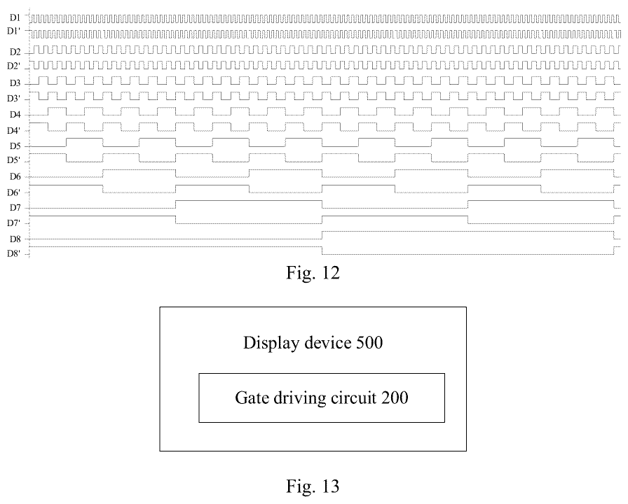

FIG. 12 is a timing diagram of a gate signal of a gate driving circuit provided by an embodiment of the present disclosure. As illustrated by FIG. 11 and FIG. 12, in a same gate driving circuit unit group 100G, gating signal lines connected with the gating circuits 160 are the same, that is, the gate driving circuit units 100 in a same gate driving circuit unit group 100G can be gated at the same time. At the same time, the gating circuits 160 in adjacent gate driving circuit unit groups 100G are connected with different gate signal lines. For example, the gating circuit 160 of another gate driving circuit unit group 100G adjacent to the gate driving circuit unit group 100G shown in FIG. 11 only needs to change the gating signal line connected to one gating sub-circuit; for example, the gating signal lines connected to the gating circuit 160 are changed from the gating signals D1, D2, D3, D4, D5, D6, D7, D8 to D1′, D2, D3, D4, D5, D6, D7, D8.

In some examples, as illustrated by FIG. 11, the first clock signal terminal CLKA of the first gate driving circuit unit 100A is connected with the first clock signal line CLK1, the second clock signal terminal CLKB of the first gate driving circuit unit 100A is connected with the second clock signal line CLK2, the third clock signal terminal CLKC of the first gate driving circuit unit 100A is connected with the third clock signal line CLK3, and the fourth clock signal terminal CLKD of the first gate driving circuit unit 100A is connected with the fourth clock signal line CLK4; the first clock signal terminal CLKA of the second gate driving circuit unit 100B is connected with the second clock signal line CLK2, the second clock signal terminal CLKB of the second gate driving circuit unit 100B is connected with the third clock signal line CLK3, the third clock signal terminal CLKC of the second gate driving circuit unit 100B is connected with the fourth clock signal line CLK4, and the fourth clock signal terminal CLKD of the second gate driving circuit unit 100B is connected with the first clock signal line CLK1; the first clock signal terminal CLKA of the third gate driving circuit unit 100C is connected with the third clock signal line CLK3, the second clock signal terminal CLKB of the third gate driving circuit unit 100C is connected with the fourth clock signal line CLK4, the third clock signal terminal CLKC of the third gate driving circuit unit 100C is connected with the first clock signal line CLK1, and the fourth clock signal terminal CLKD of the third gate driving circuit unit 100C is connected with the second clock signal line CLK2; the first clock signal terminal CLKA of the fourth gate driving circuit unit 100D is connected with the fourth clock signal line CLK4, the second clock signal terminal CLKB of the fourth gate driving circuit unit 100D is connected with the first clock signal line CLK1, the third clock signal terminal CLKC of the fourth gate driving circuit unit 100D is connected with the second clock signal line CLK2, and the fourth clock signal terminal CLKD of the fourth gate driving circuit unit 100D is connected with the third clock signal line CLK3, and so on.

At least one embodiment of the present disclosure further provides a display device. FIG. 13 is a schematic diagram of a display device provided by an embodiment of the present disclosure. As illustrated by FIG. 13, the display device 500 includes the gate driving circuit 200 described above. In this way, the display device can also partially refresh the display screen without performing line-by-line scanning, thus the refresh frequency is greatly improved; for example, in a case that only a partial region of the display screen needs to be refreshed, only the partial region of the display screen can be refreshed specifically, thus the refresh frequency is greatly improved. On the other hand, the display device can also effectively eliminate the compensation horizontal stripes.

In some examples, the display device may be an electronic product with a display function, such as a television, a monitor, an electronic picture frame, an electronic photo frame, a navigator, a laptop computer, a tablet computer, a smart phone, or the like.

At least one embodiment of the present disclosure further provides a driving method of a gate driving circuit unit, and the gate driving circuit unit may be the gate driving circuit unit provided by any one of the above examples. At this time, the driving method may include the following steps.
In a first stage, the pre-charging circuit responds to a signal on the second clock signal terminal, writes the first power supply voltage into the third node, and turns on the second input circuit;
In a second stage, the first input circuit responds to a signal on the control terminal of the first input circuit and pulls up a potential of the second node through the conducted second input circuit;
In a third stage, the second node maintains a high level, and the output circuit responds to a signal of the second node and outputs the signal on the first clock signal terminal as a gate drive signal; and
In a fourth stage, the first pull-down circuit responds to a signal on the third clock signal terminal and uses the second power supply voltage to pull down the potential of the second node.

In the driving method of the gate driving circuit unit provided by the embodiment of the present disclosure, in the first stage, the pre-charging circuit can be controlled by the signal on the second clock signal terminal to write the first power supply voltage into the third node, and the second input circuit is conducted, in the second stage, the potential on the second node can be pulled high through the first input circuit and the second input circuit, and in the third stage, the signal on the first clock signal terminal can be output as a gate driving signal through the output circuit, in the fourth stage, the first pull-down circuit can be controlled by the signal on the third clock signal terminal to pull down the potential of the second node. In this way, the driving method of the gate driving circuit unit controls the second input circuit and the first pull-down circuit through a clock signal without cascading, thus the gate driving circuit unit can work independently, so that the gate driving circuit using the gate driving circuit unit can randomly select a certain sub-pixel row. In this way, on the one hand, the gate driving circuit using the gate driving circuit unit can partially refresh the display screen without performing line-by-line scanning, thus the refresh frequency is greatly improved; for example, in a case that only a partial region of the display screen needs to be refreshed, only the partial region of the display screen can be refreshed specifically, thus the refresh rate can be greatly improved. On the other hand, the gate driving circuit using the gate driving circuit unit can output “random frame shift”, thus the compensation horizontal stripes can be effectively eliminated.

In some examples, the first pull-down circuit may also respond to other signals to utilize the second power supply voltage to pull down the potential of the second node.

The following points need to be explained:
a) In the drawings of the embodiment of the present disclosure, only the structures related to the embodiment of the present disclosure are involved, and other structures can refer to the general design.
b) In case of no conflict, features in the same embodiment and different embodiments of the present disclosure can be combined with each other.

The above is only the specific implementation of the present disclosure, but the protection scope of the present disclosure is not limited thereto. Any person familiar with this technical field can easily think of changes or substitutions within the technical scope disclosed in the present disclosure, which should be included in the protection scope of the present disclosure. Therefore, the scope of protection of the present disclosure should be based on the scope of protection of the claims.

1. A gate driving circuit unit, comprising:
a first input circuit, comprising a control terminal, an input terminal and an output terminal, wherein the input terminal of the first input circuit is connected with a first power supply voltage;
a second input circuit, comprising a control terminal, an input terminal and an output terminal;
an output circuit, comprising a control terminal, an input terminal and an output terminal, wherein the input terminal of the output circuit is connected with a first clock signal terminal;
a pre-charging circuit, comprising a control terminal, an input terminal and an output terminal, wherein the control terminal of the pre-charging circuit is connected with a second clock signal terminal, and the input terminal of the pre-charging circuit is connected with the first power supply voltage; and
a first pull-down circuit, comprising a control terminal, an input terminal and an output terminal,
wherein the output terminal of the first input circuit and the input terminal of the second input circuit are connected with a first node, the output terminal of the second input circuit and the control terminal of the output circuit are connected with a second node, the output terminal of the pre-charging circuit and the control terminal of the second input circuit are connected with a third node,
the first pull-down circuit is configured to pull down a potential of the second node.

2. The gate driving circuit unit according to claim 1, wherein the control terminal of the first pull-down circuit is connected with a third clock signal terminal, and is configured to pull down the potential of the second node in response to a signal on the third clock signal terminal.

3. The gate driving circuit unit according to claim 2, further comprising:
a pull-down maintenance circuit, comprising a control terminal, an input terminal and an output terminal, wherein the input terminal of the pull-down maintenance circuit is connected with the third node, and the output terminal of the pull-down maintenance circuit is connected with the second clock signal terminal; and
a gating circuit, comprising an input terminal, an output terminal and a plurality of gating sub-circuits connected in parallel between the input terminal and the output terminal of the gating circuit,
wherein the input terminal of the gating circuit is connected with the control terminal of the pull-down maintenance circuit, and the output terminal of the gating circuit is connected with the third clock signal terminal.

4. The gate driving circuit unit according to claim 3, wherein each of the gating sub-circuits comprises a gating transistor, the gating transistor comprises a gate electrode, a first electrode and a second electrode, the first electrode of the gating transistor is connected with the input terminal of the gating circuit, and the second electrode of the gating transistor is connected with the output terminal of the gating circuit.

5. The gate driving circuit unit according to claim 3, wherein the pull-down maintenance circuit comprises a first pull-down maintenance transistor and a second pull-down maintenance transistor, the first pull-down maintenance transistor comprises a gate electrode, a first electrode and a second electrode, and the second pull-down maintenance transistor comprises a gate electrode, a first electrode and a second electrode,
the first electrode of the first pull-down maintenance transistor is connected with the third node, the output terminal of the first pull-down maintenance transistor is connected with the input terminal of the second pull-down maintenance transistor, and the output terminal of the second pull-down maintenance transistor is connected with the second clock signal terminal.

6. The gate driving circuit unit according to claim 1, wherein the input terminal of the first pull-down circuit is connected to the second node, and the output terminal of the first pull-down circuit is connected with a second power supply voltage.

7. The gate driving circuit unit according to claim 6, wherein the first pull-down circuit comprises a first pull-down transistor and a second pull-down transistor, the first pull-down transistor comprises a gate electrode, a first electrode, and a second electrode, and the second pull-down transistor comprises a gate electrode, a first electrode, and a second electrode,
the first electrode of the first pull-down transistor is connected with the second node, the second electrode of the first pull-down transistor is connected with the first electrode of the second pull-down transistor, and the second electrode of the second pull-down transistor is connected with the second power supply voltage.

8. The gate driving circuit unit according to claim 1, further comprising:
an inverter module, comprising a control terminal and an output terminal,
wherein the control terminal of the inverter module is connected to the second node, and the output terminal of the inverter module is connected to a fourth node; and
a first noise reduction circuit, comprising a control terminal, an input terminal and an output terminal, wherein the input terminal of the first noise reduction circuit is connected to the first node, the control terminal of the first noise reduction circuit is connected to the fourth node, and the output terminal of the first noise reduction circuit is connected with a second power supply voltage; and
the input terminal of the first pull-down circuit is connected with the first power supply voltage, and the output terminal of the first pull-down circuit is connected to the fourth node.

9. The gate driving circuit unit according to claim 1, further comprising:
an inverter module, comprising a control terminal and an output terminal,
wherein the control terminal of the inverter module is connected to the second node, and the output terminal of the inverter module is connected to a fourth node; and
a first noise reduction circuit, comprising a control terminal, an input terminal and an output terminal, wherein the input terminal of the first noise reduction circuit is connected to the first node, the control terminal of the first noise reduction circuit is connected to the fourth node, and the output terminal of the first noise reduction circuit is connected with a second power supply voltage.

10. The gate driving circuit unit according to claim 9, wherein the first noise reduction circuit comprises a first noise reduction transistor and a second noise reduction transistor, the first noise reduction transistor comprises a gate electrode, a first electrode and a second electrode, and the second noise reduction transistor comprises a gate electrode, a first electrode and a second electrode;
the first electrode of the first noise reduction transistor is connected with the first node, the second electrode of the first noise reduction transistor is connected with the first electrode of the second noise reduction transistor, and the second electrode of the second noise reduction transistor is connected with the second power supply voltage,
the gate electrode of the first noise reduction transistor and the gate electrode of the second noise reduction transistor are connected with the fourth node.

11. The gate driving circuit unit according to claim 9, further comprising:
a second pull-down circuit, comprising a control terminal, an input terminal and an output terminal;
a third pull-down circuit, comprising a control terminal, an input terminal and an output terminal;
wherein, the input terminal of the second pull-down circuit is connected with the fourth node, the output terminal of the second pull-down circuit is connected with the input terminal of the third pull-down circuit, and the output terminal of the third pull-down circuit is connected with the second power supply voltage;
the control terminal of the second pull-down circuit is connected with the third node, and the control terminal of the third pull-down circuit is connected with a fourth clock signal terminal.

12. The gate driving circuit unit according to claim 11, wherein the second pull-down circuit comprises a third pull-down transistor, comprising a gate electrode, a first electrode and a second electrode, the third pull-down circuit comprises a fourth pull-down transistor, comprising a gate electrode, a first electrode and a second electrode,
the first electrode of the third pull-down transistor is connected with the fourth node, the second electrode of the third pull-down transistor is connected with the first electrode of the fourth pull-down transistor, and the second electrode of the fourth pull-down transistor is connected with the second power supply voltage, and
the gate electrode of the third pull-down transistor is connected with the third node, and the gate electrode of the fourth pull-down transistor is connected with the fourth clock signal terminal.

13. The gate driving circuit unit according to claim 9, further comprising:
a second noise reduction circuit, comprising a control terminal, an input terminal and an output terminal; and
a third noise reduction circuit, comprising a control terminal, an input terminal and an output terminal,
wherein the input terminal of the second noise reduction circuit is connected with the second node, the output terminal of the second noise reduction circuit is connected with the second power supply voltage, and the control terminal of the second noise reduction circuit is connected with the fourth node,
the input terminal of the third noise reduction circuit is connected with the output terminal of the output circuit, the output terminal of the third noise reduction circuit is connected with a third power supply voltage, and the control terminal of the third noise reduction circuit is connected with the fourth node.

14. (canceled)

15. The gate driving circuit unit according to claim 9, further comprising:
a global reset circuit, comprising a first reset sub-circuit and a second reset sub-circuit, wherein the first reset sub-circuit comprises a control terminal, an input terminal and an output terminal, and the second reset sub-circuit comprises a control terminal, an input terminal and an output terminal,
the input terminal of the first reset sub-circuit is connected with the third node, and the output terminal of the first reset sub-circuit is connected with the second power supply voltage,
the input terminal of the second reset sub-circuit is connected with the first power supply voltage, and the output terminal of the second reset sub-circuit is connected with the fourth node,
the control terminal of the first reset sub-circuit and the control terminal of the second reset sub-circuit are both connected with a global reset signal.

16. The gate driving circuit unit according to claim 1, wherein the first input circuit comprises a first input transistor, the second input circuit comprises a second input transistor,
the first input transistor comprises a gate electrode, a first electrode and a second electrode, and the second input transistor comprises a gate electrode, a first electrode and a second electrode,
the first electrode of the first input transistor is connected with the first power supply voltage, the second electrode of the first input transistor is connected with the first electrode of the second input transistor, and the second electrode of the second input transistor is connected with the second node, and
the gate electrode of the first input transistor is connected with a fourth clock signal terminal, and the gate electrode of the second input transistor is connected with the third node.

17. The gate driving circuit unit according to claim 1, wherein the first input circuit comprises a first input transistor and a third input transistor, the second input circuit comprises a second input transistor,
the first input transistor comprises a gate electrode, a first electrode and a second electrode, the second input transistor comprises a gate electrode, a first electrode and a second electrode, and the third input transistor comprises a gate electrode, a first electrode and a second electrode,
the second electrode of the first input transistor is connected with the first electrode of the third input transistor, and the first electrode of the first input transistor, the gate electrode of the first input transistor, and the gate electrode of the third input transistor are connected with the fourth clock signal terminal,
the second electrode of the third input transistor and the first electrode of the second input transistor are connected to the first node, and the gate electrode of the second input transistor is connected with the third node.

18. A gate driving circuit, comprising a plurality of gate driving circuit units, wherein each of the gate driving circuits comprises the gate driving circuit unit according to claim 1.

19. The gate driving circuit according to claim 18, wherein the plurality of gate driving circuit units comprise a plurality of gate driving circuit unit groups, each of the plurality of gate driving circuit unit groups comprises a first gate driving circuit unit, a second gate driving circuit unit, a third gate driving circuit unit and a fourth gate driving circuit unit,
the first clock signal terminal of the first gate driving circuit unit is connected with a first clock signal line, the first clock signal terminal of the first gate driving circuit unit is connected with a second clock signal line, the first clock signal terminal of the first gate driving circuit unit is connected with a third clock signal line, and the first clock signal terminal of the first gate driving circuit unit is connected with a fourth clock signal line.

20. A display device, comprising the gate driving circuit according to claim 18.

21. A driving method for a gate driving circuit unit, wherein the gate driving circuit unit comprises the gate driving circuit unit according to claim 1, and the driving method comprises:
in a first stage, the pre-charging circuit responds to a signal on the second clock signal terminal, writes a first power supply voltage into the third node, and conducts a second input circuit;
in a second stage, the first input circuit responds to a signal on the control terminal of the first input circuit, and pulls up the potential of the second node through the conducted second input circuit;
in a third stage, the second node maintains a high level, and the output circuit responds to a signal of the second node, and outputs a signal on the first clock signal terminal as a gate drive signal; and
in a fourth stage, the first pull-down circuit uses a second power supply voltage to pull down the potential of the second node.
